(19) United States
(12) Patent Application Publication
(10) Pub. No.: US 2026/0156488 A1
(43) Pub. Date: Jun. 4, 2026

(54) METHOD, COMMUNICATION EQUIPMENT, PROCESSING DEVICE, AND STORAGE MEDIUM FOR UPDATING KNOWLEDGE FOR SEMANTIC COMMUNICATION IN WIRELESS COMMUNICATION SYSTEM

(71) Applicant: LG ELECTRONICS INC., Seoul (KR)

(72) Inventors: Ikjoo JUNG, Seoul (KR); Sangrim LEE, Seoul (KR); Kyungho LEE, Seoul (KR); Taehyun LEE, Seoul (KR); Minseok JO, Seoul (KR)

(21) Appl. No.: 18/715,443

(22) PCT Filed: Dec. 2, 2021
(86) PCT No.: PCT/KR2021/018109

§ 371 Date: May 31, 2024

(51) Int. Cl. H04W 24/02; G06F 40/30

(52) U.S. Cl. CPC H04W 24/02; G06F 40/30

(57) ABSTRACT

This communication equipment can update knowledge for semantic communication in a wireless communication system. This communication equipment can update knowledge for semantic communication in a wireless communication system. For example, the communication equipment can: determine a first sub-graph from graph data representing the knowledge; determine a first potential vector on the basis of pooling the first sub-graph; receive a second potential vector, a second feature map, and a second node index from other communication equipment; determine, on the basis of the first potential vector and the second potential vector, whether to update the graph data; on the basis of determining to update the graph data, recover a second sub-graph through un-pooling the second potential vector on the basis of the second feature map and the second node index; and update the graph data on the basis of the second sub-graph.

### CROSS-REFERENCE TO RELATED APPLICATIONS

This application is a National Phase application under 35 U.S.C. 371 of International Application No. PCT/KR2021/018109, filed on Dec. 2, 2021, the contents of which are incorporated by reference herein in their entirety.

### TECHNICAL FIELD

The present disclosure relates to a wireless communication system.

### BACKGROUND

A variety of technologies, such as machine-to-machine (M2M) communication, machine type communication (MTC), and a variety of devices demanding high data throughput, such as smartphones and tablet personal computers (PCs), have emerged and spread. Accordingly, the volume of data throughput demanded to be processed in a cellular network has rapidly increased. In order to satisfy such rapidly increasing data throughput, carrier aggregation technology or cognitive radio technology for efficiently employing more frequency bands and multiple input multiple output (MIMO) technology or multi-base station (BS) cooperation technology for raising data capacity transmitted on limited frequency resources have been developed.

As more and more communication devices have required greater communication capacity, there has been a need for enhanced mobile broadband (eMBB) communication relative to legacy radio access technology (RAT). In addition, massive machine type communication (mMTC) for providing various services at anytime and anywhere by connecting a plurality of devices and objects to each other is one main issue to be considered in next-generation (e.g., 5G) communication.

Communication system design considering services/user equipment (UEs) sensitive to reliability and latency is also under discussion. The introduction of next-generation RAT is being discussed in consideration of eMBB communication, mMTC, ultra-reliable and low-latency communication (URLLC), and the like.

While 5G communication is still under development, there is an increasing demand for higher data rates to accommodate new services such as virtual reality and autonomous driving.

### SUMMARY

As new radio communication technology has been introduced, the number of UEs to which a BS should provide services in a prescribed resource region is increasing and the volume of data and control information that the BS transmits/receives to/from the UEs to which the BS provides services is also increasing. Since the amount of resources available to the BS for communication with the UE(s) is limited, a new method for the BS to efficiently receive/transmit uplink/downlink data and/or uplink/downlink control information from/to the UE(s) using the limited radio resources is needed. In other words, due to increase in the density of nodes and/or the density of UEs, a method for efficiently using high-density nodes or high-density UEs for communication is needed.

A method to efficiently support various services with different requirements in a wireless communication system is also needed.

Overcoming delay or latency is an important challenge to applications, performance of which is sensitive to delay/latency.

There is a need for a method of efficiently performing semantic communication.

The objects to be achieved with the present disclosure are not limited to what has been particularly described hereinabove and other objects not described herein will be more clearly understood by persons skilled in the art from the following detailed description.

According to an aspect of the present disclosure, provided is a method of updating knowledge for semantic communication by a communication device in a wireless communication system. The method may include determining a first subgraph from graph data representing the knowledge, determining a first latent vector based on pooling for the first subgraph, receiving a second latent vector, a second feature map, and a second node index from another communication device, determining whether to update the graph data based on the first latent vector and the second latent vector, restoring a second subgraph through un-pooling for the second latent vector based on the second feature map and the second node index, based on a determination to update the graph data, and updating the graph data based on the second subgraph.

According to another aspect of the present disclosure, provided is a communication device for updating knowledge for semantic communication in a wireless communication system. The communication device may include at least one transceiver, at least one processor, and at least one computer memory operably connected to the at least one processor and configured to store instructions that, when executed, cause the at least one processor to perform operations. The operations may include determining a first subgraph from graph data representing the knowledge, determining a first latent vector based on pooling for the first subgraph, receiving a second latent vector, a second feature map, and a second node index from another communication device, determining whether to update the graph data based on the first latent vector and the second latent vector, restoring a second subgraph through un-pooling for the second latent vector based on the second feature map and the second node index, based on a determination to update the graph data, and updating the graph data based on the second subgraph.

According to another aspect of the present disclosure, provided is a processing device for a communication device. The processing device may include at least one processor, and at least one computer memory operably connected to the at least one processor and configured to store instructions that, when executed, cause the at least one processor to perform operations. The operations may include determining a first subgraph from graph data representing knowledge, determining a first latent vector and a first feature map based on pooling for the first subgraph, receiving a second latent vector and a second feature map from another communication device, determining a first latent vector based on pooling for the first subgraph, receiving a second latent vector, a second feature map, and a second node index from another communication device, determining whether to update the graph data based on the first latent vector and the second latent vector, restoring a second subgraph through un-pooling for the second latent vector based on the second feature map and the second node index, based on a determination to update the graph data, and updating the graph data based on the second subgraph.

According to another aspect of the present disclosure, provided is a computer-readable storage medium. The storage medium may store at least one program code including instructions that, when executed by at least one processor, cause the at least one processor to perform operations. The operations may include determining a first subgraph from graph data representing knowledge, determining a first latent vector based on pooling for the first subgraph, receiving a second latent vector, a second feature map, and a second node index from another communication device, determining whether to update the graph data based on the first latent vector and the second latent vector, restoring a second subgraph through un-pooling for the second latent vector based on the second feature map and the second node index, based on a determination to update the graph data, and updating the graph data based on the second subgraph.

According to each aspect of the present disclosure, the communication device may include an encoder including d encoding blocks each including a graph neural network (GNN) layer and a pooling layer. Determining the first latent vector may include inputting the first subgraph to the encoder, generating an output feature map of a l-th encoding block by aggregating features of nodes belonging to a subgraph input to the l-th encoding block through a GNN layer of the l-th encoding block, selecting a preconfigured number of nodes through a pooling layer of the l-th encoding block and determining an output subgraph of the l-th encoding block based on the selected nodes, inputting the output subgraph of the l-th encoding block to a (l+1)-th encoding block based on (l+1) being not greater than d, and determining the first latent vector from the output subgraph of the l-th encoding block based on (l+1) being greater than d.

According to each aspect of the present disclosure, the method may further include transmitting a feature map for each GNN layer of the communication device and node indexes of nodes selected for each pooling layer of the communication device to the other communication device.

According to each aspect of the present disclosure, the communication device may include a decoder including d decoding blocks each including a graph neural network (GNN) layer and an un-pooling layer.

According to each aspect of the present disclosure, the receiving of the second latent vector, the second feature map, and the second node index from the other communication device may include receiving a feature map for each GNN layer of the other communication device and node indexes for each pooling layer of the other communication device.

According to each aspect of the present disclosure, restoring the second subgraph through un-pooling for the second latent vector based on the second feature map and the second node index may include inputting the second latent vector, the second feature map, and the second node index to the decoder, based on l=1, restoring an output subgraph of the l-th decoding block based on the second latent vector, the second feature map, and the second node index through an un-pooling layer of the l-th decoding block, and based on l>1, restoring the output subgraph of the l-th decoding block based on a feature map of the l-th decoding block and a feature map and node index of a peer encoding block of the l-th decoding block from among encoding blocks of the other communication device through the l-th decoding block, determining the feature map of the l-th decoding block by combining the output subgraph of the l-th decoding block through a GNN layer of the l-th decoding block with a feature map of the peer encoding block of the l-th decoding block from among encoding blocks of the other communication device, based on (l+1) being not greater than d, inputting the feature map of the l-th decoding block to a (l+1)-th decoding block, and determining the output subgraph of the l-th decoding block as the second subgraph based on (l+1) being greater than d.

According to each aspect of the present disclosure, determining whether to update the graph data based on the first latent vector and the second latent vector may include determining to update the graph data based on a similarity between the first latent vector and the second latent vector is lower than a predetermined threshold.

According to each aspect of the present disclosure, updating the graph data based on the second subgraph may include updating a node or an edge of the first subgraph based on the second subgraph.

The foregoing solutions are merely a part of the examples of the present disclosure and various examples into which the technical features of the present disclosure are incorporated may be derived and understood by persons skilled in the art from the following detailed description.

According to implementations of the present disclosure, a wireless communication signal may be efficiently transmitted/received. Accordingly, the overall throughput of a wireless communication system may be improved.

According to implementations of the present disclosure, a wireless communication system may efficiently support various services with different requirements.

According to implementations of the present disclosure, delay/latency occurring during wireless communication between communication devices may be reduced.

According to implementations of the present disclosure, semantic communication may be efficiently performed.

The effects according to the present disclosure are not limited to what has been particularly described hereinabove and other effects not described herein will be more clearly understood by persons skilled in the art related to the present disclosure from the following detailed description.

### BRIEF DESCRIPTION OF THE DRAWINGS

The accompanying drawings, which are included to provide a further understanding of the present disclosure, illustrate examples of implementations of the present disclosure and together with the detailed description serve to explain implementations of the present disclosure:

FIG. 1 illustrates an example of a communication system 1 to which implementations of the present disclosure are applied;

FIG. 2 is a block diagram illustrating examples of communication devices capable of performing a method according to the present disclosure;

FIG. 3 illustrates another example of a wireless device capable of performing implementation(s) of the present disclosure;

FIG. 4 illustrates a perceptron structure used in an artificial neural network;

FIG. 5 illustrates a multilayer perceptron structure;

FIG. 6 illustrates the structure of a convolutional neural network (CNN);

FIG. 7 illustrates a filtering operation in a CNN;

FIG. 8 illustrates a three-level communication model to which implementations of the present disclosure are applicable;

FIG. 9 illustrates an operation of a graph neural network (GNN);

FIG. 10 illustrates a GNN model for a target node;

FIG. 11 illustrates an encoder-decoder structure that introduces a pooling-based GNN to semantic communication;

FIG. 12 illustrates a process of updating graph data in a GNN that utilizes a pooling scheme for semantic communication in some implementations of the present disclosure;

FIG. 13 illustrates a flow of initialization related to graph data processing for semantic communication in several implementations of the present disclosure;

FIG. 14 illustrates a node pair and an edge to which a score function is applied in several implementations of the present disclosure;

FIG. 15 illustrates a process related to extraction of a subgraph and related to generation/storage/transmission of related information according to some implementations of the present disclosure;

FIG. 16 shows an example of an encoding process in a GNN model using a pooling scheme according to some implementations of the present disclosure;

FIG. 17 illustrates a process of processing subgraph-based latent vector(s) according to some implementations of the present disclosure;

FIG. 18 shows an example of a decoding process in a GNN model using a pooling scheme according to some implementations of the present disclosure; and

FIG. 19 shows an example of a process of updating a graph encoder/decoder to apply updated graph data according to some implementations of the present disclosure.

### DETAILED DESCRIPTION

Hereinafter, implementations according to the present disclosure will be described in detail with reference to the accompanying drawings. The detailed description, which will be given below with reference to the accompanying drawings, is intended to explain exemplary implementations of the present disclosure, rather than to show the only implementations that may be implemented according to the present disclosure. The following detailed description includes specific details in order to provide a thorough understanding of the present disclosure. However, it will be apparent to those skilled in the art that the present disclosure may be practiced without such specific details.

In some instances, known structures and devices may be omitted or may be shown in block diagram form, focusing on important features of the structures and devices, so as not to obscure the concept of the present disclosure. The same reference numbers will be used throughout the present disclosure to refer to the same or like parts.

A technique, a device, and a system described below may be applied to a variety of wireless multiple access systems. The multiple access systems may include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, a multi-carrier frequency division multiple access (MC-FDMA) system, etc. CDMA may be implemented by radio technology such as universal terrestrial radio access (UTRA) or CDMA2000. TDMA may be implemented by radio technology such as global system for mobile communications (GSM), general packet radio service (GPRS), enhanced data rates for GSM evolution (EDGE) (i.e., GERAN), etc. OFDMA may be implemented by radio technology such as institute of electrical and electronics engineers (IEEE) 802.11 (Wi-Fi), IEEE 802.16 (WiMAX), IEEE 802.20, evolved-UTRA (E-UTRA), etc. UTRA is part of universal mobile telecommunications system (UMTS) and 3rd generation partnership project (3GPP) long-term evolution (LTE) is part of E-UMTS using E-UTRA. 3GPP LTE adopts OFDMA on downlink (DL) and adopts SC-FDMA on uplink (UL). LTE-advanced (LTE-A) is an evolved version of 3GPP LTE.

For convenience of description, description will be given under the assumption that the present disclosure is applied to LTE and/or new RAT (NR). However, the technical features of the present disclosure are not limited thereto. For example, although the following detailed description is given based on mobile communication systems corresponding to 3GPP LTE/NR systems, the mobile communication systems are applicable to other arbitrary mobile communication systems except for matters that are specific to the 3GPP LTE/NR system.

For terms and techniques that are not described in detail among terms and techniques used in the present disclosure, reference may be made to 3GPP based standard specifications, for example, 3GPP TS 36.211, 3GPP TS 36.212, 3GPP TS 36.213, 3GPP TS 36.321, 3GPP TS 36.300, 3GPP TS 36.331, 3GPP TS 37.213, 3GPP TS 38.211, 3GPP TS 38.212, 3GPP TS 38.213, 3GPP TS 38.214, 3GPP TS 38.300, 3GPP TS 38.331, etc.

In examples of the present disclosure described later, if a device “assumes” something, this may mean that a channel transmission entity transmits a channel in compliance with the corresponding “assumption”. This also may mean that a channel reception entity receives or decodes the channel in the form of conforming to the “assumption” on the premise that the channel has been transmitted in compliance with the “assumption”.

In the present disclosure, a user equipment (UE) may be fixed or mobile. Each of various devices that transmit and/or receive user data and/or control information by communicating with a base station (BS) may be the UE. The term UE may be referred to as terminal equipment, mobile station (MS), mobile terminal (MT), user terminal (UT), subscriber station (SS), wireless device, personal digital assistant (PDA), wireless modem, handheld device, etc. In the present disclosure, the term user is used to refer to a UE. In the present disclosure, a BS refers to a fixed station that communicates with a UE and/or another BS and exchanges data and control information with a UE and another BS. The term BS may be referred to as advanced base station (ABS), Node-B (NB), evolved Node-B (eNB), base transceiver system (BTS), access point (AP), processing server (PS), etc. Particularly, a BS of a universal terrestrial radio access (UTRAN) is referred to as an NB, a BS of an evolved-UTRAN (E-UTRAN) is referred to as an eNB, and a BS of new radio access technology network is referred to as a gNB. Hereinbelow, for convenience of description, the NB, eNB, or gNB will be referred to as a BS regardless of the type or version of communication technology.

In the present disclosure, a transmission and reception point (TRP) refers to a fixed point capable of transmitting/receiving a radio signal to/from a UE by communication with the UE. Various types of BSs may be used as TRPs regardless of the names thereof. For example, a BS, NB, eNB, pico-cell eNB (PeNB), home eNB (HeNB), relay, repeater, etc. may be a TRP. Furthermore, a TRP may not be a BS. For example, a radio remote head (RRH) or a radio remote unit (RRU) may be a TRP. Generally, the RRH and RRU have power levels lower than that of the BS. Since the RRH or RRU (hereinafter, RRH/RRU) is connected to the BS through a dedicated line such as an optical cable in general, cooperative communication according to the RRH/RRU and the BS may be smoothly performed relative to cooperative communication according to BSs connected through a wireless link. At least one antenna is installed per TRP. An antenna may refer to a physical antenna port or refer to a virtual antenna or an antenna group. The TRP may also be called a point.

In the present disclosure, a cell refers to a specific geographical area in which one or more TRPs provide communication services. Accordingly, in the present disclosure, communication with a specific cell may mean communication with a BS or a TRP providing communication services to the specific cell. A DL/UL signal of the specific cell refers to a DL/UL signal from/to the BS or the TRP providing communication services to the specific cell. A cell providing UL/DL communication services to a UE is especially called a serving cell. Furthermore, channel status/quality of the specific cell refers to channel status/quality of a channel or a communication link generated between the BS or the TRP providing communication services to the specific cell and the UE. In 3GPP-based communication systems, the UE may measure a DL channel state from a specific TRP using cell-specific reference signal(s) (CRS(s)) transmitted on a CRS resource and/or channel state information reference signal(s) (CSI-RS(s)) transmitted on a CSI-RS resource, allocated to the specific TRP by antenna port(s) of the specific TRP.

A 3GPP-based communication system uses the concept of a cell in order to manage radio resources, and a cell related with the radio resources is distinguished from a cell of a geographic area.

The “cell” of the geographic area may be understood as coverage within which a TRP may provide services using a carrier, and the “cell” of the radio resources is associated with bandwidth (BW), which is a frequency range configured by the carrier. Since DL coverage, which is a range within which the TRP is capable of transmitting a valid signal, and UL coverage, which is a range within which the TRP is capable of receiving the valid signal from the UE, depend upon a carrier carrying the signal, coverage of the TRP may also be associated with coverage of the “cell” of radio resources used by the TRP. Accordingly, the term “cell” may be used to indicate service coverage by the TRP sometimes, radio resources at other times, or a range that a signal using the radio resources may reach with valid strength at other times.

In 3GPP communication standards, the concept of the cell is used in order to manage radio resources. The “cell” associated with the radio resources is defined by a combination of DL resources and UL resources, that is, a combination of a DL component carrier (CC) and a UL CC. The cell may be configured by the DL resources only or by the combination of the DL resources and the UL resources. If carrier aggregation is supported, linkage between a carrier frequency of the DL resources (or DL CC) and a carrier frequency of the UL resources (or UL CC) may be indicated by system information. In this case, the carrier frequency may be equal to or different from a center frequency of each cell or CC.

In a wireless communication system, the UE receives information on DL from the BS and the UE transmits information on UL to the BS. The information that the BS and UE transmit and/or receive includes data and a variety of control information and there are various physical channels according to types/usage of the information that the UE and the BS transmit and/or receive.

The 3GPP-based communication standards define DL physical channels corresponding to resource elements carrying information originating from a higher layer and DL physical signals corresponding to resource elements which are used by the physical layer but do not carry the information originating from the higher layer. For example, a physical downlink shared channel (PDSCH), a physical broadcast channel (PBCH), a physical multicast channel (PMCH), a physical control format indicator channel (PCFICH), a physical downlink control channel (PDCCH), etc. are defined as the DL physical channels, and a reference signal (RS) and a synchronization signal (SS) are defined as the DL physical signals. The RS, which is also referred to as a pilot, represents a signal with a predefined special waveform known to both the BS and the UE. For example, a demodulation reference signal (DMRS), a channel state information RS (CSI-RS), etc. are defined as DL RSs. The 3GPP-based communication standards define UL physical channels corresponding to resource elements carrying information originating from the higher layer and UL physical signals corresponding to resource elements which are used by the physical layer but do not carry the information originating from the higher layer. For example, a physical uplink shared channel (PUSCH), a physical uplink control channel (PUCCH), and a physical random access channel (PRACH) are defined as the UL physical channels, and a DMRS for a UL control/data signal, a sounding reference signal (SRS) used for UL channel measurement, etc. are defined.

In the present disclosure, the PDCCH refers to a set of time-frequency resources (e.g., a set of resource elements (REs)) that carry downlink control information (DCI), and the PDSCH refers to a set of time-frequency resources (e.g., a set of REs) that carry DL data. The PUCCH, PUSCH, and PRACH refer to a set of time-frequency resources (i.e., a set of REs) that carry uplink control information (UCI), UL data, and random access signals, respectively. In the following description, the meaning of “The UE transmits/receives the PUCCH/PUSCH/PRACH” is that the UE transmits/receives the UCI/UL data/random access signals on or through the PUCCH/PUSCH/PRACH, respectively. In addition, the meaning of “the BS transmits/receives the PBCH/PDCCH/PDSCH” is that the BS transmits the broadcast information/DCI/DL data on or through a PBCH/PDCCH/PDSCH, respectively.

In the present disclosure, a radio resource (e.g., a time-frequency resource) scheduled or configured for the UE by the BS for transmission or reception of PUCCH/PUSCH/PDSCH is also referred to as a PUCCH/PUSCH/PDSCH resource.

Since a communication device receives an SS/PBCH resource block (SSB), DMRS, CSI-RS, PBCH, PDCCH, PDSCH, PUSCH, and/or PUCCH in the form of radio signals on a cell, the communication device may not select and receive radio signals including only a specific physical channel or a specific physical signal through a radio frequency (RF) receiver, or may not select and receive radio signals without a specific physical channel or a specific physical signal through the RF receiver. In actual operations, the communication device receives radio signals on the cell via the RF receiver, converts the radio signals, which are RF band signals, into baseband signals, and then decodes physical signals and/or physical channels in the baseband signals using one or more processors. Thus, in some implementations of the present disclosure, not receiving physical signals and/or physical channels may mean that a communication device does not attempt to restore the physical signals and/or physical channels from radio signals, for example, does not attempt to decode the physical signals and/or physical channels, rather than that the communication device does not actually receive the radio signals including the corresponding physical signals and/or physical channels.

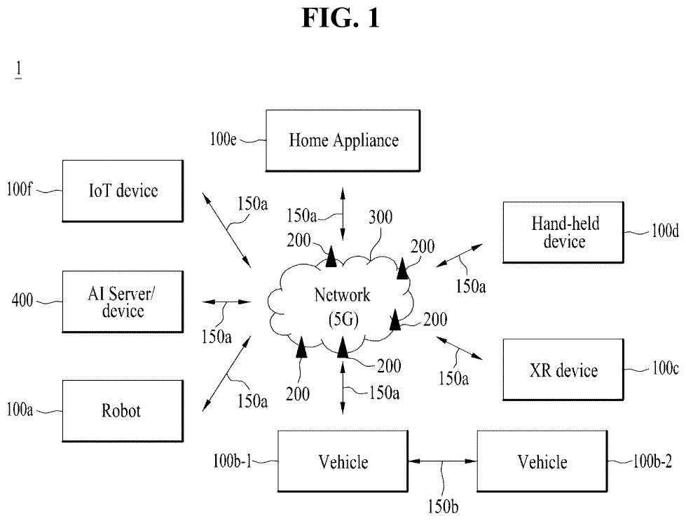

FIG. 1 illustrates an example of a communication system 1 to which implementations of the present disclosure are applied. Referring to FIG. 1, the communication system 1 applied to the present disclosure includes wireless devices, BSs, and a network. Here, the wireless devices represent devices performing communication using radio access technology (RAT) (e.g., 5G New RAT (NR) or LTE (e.g., E-UTRA), 6G) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Here, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may also be implemented as wireless devices and a specific wireless may operate as a BS/network node with respect to another wireless device.

The wireless devices 100a to 100f may be connected to a network 300 via BSs 200. AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network or 6G network to be introduced in the future. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. vehicle-to-vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f and the BSs 200 and between the wireless devices 100a to 100f). Here, the wireless communication/connections such as UL/DL communication 150a and sidelink communication 150b (or, device-to-device (D2D) communication) may be established by various RATs. The wireless devices and the BSs/wireless devices may transmit/receive radio signals to/from each other through the wireless communication/connections 150a and 150b. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

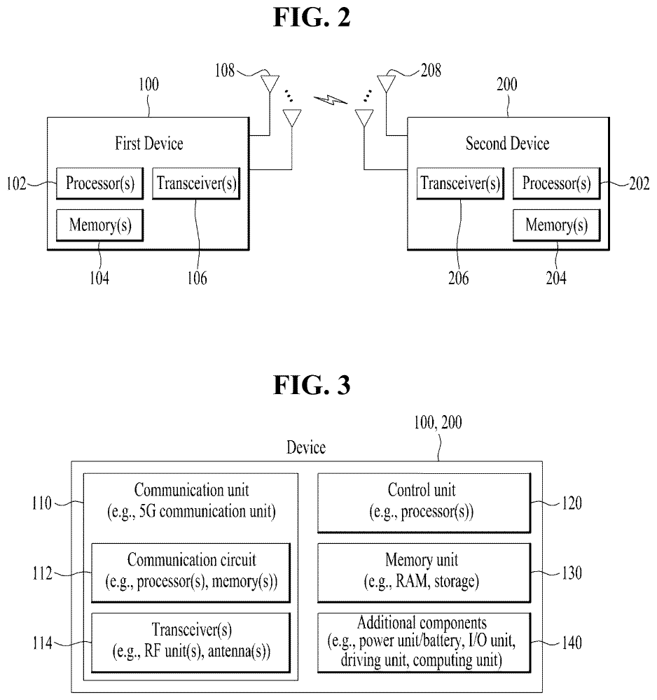

FIG. 2 is a block diagram illustrating examples of communication devices capable of performing a method according to the present disclosure. Referring to FIG. 2, a first wireless device 100 and a second wireless device 200 may transmit and/or receive radio signals through a variety of RATs. Here, {the first wireless device 100 and the second wireless device 200} may correspond to {the wireless device 100x and the BS 200} and/or {the wireless device 100x and the wireless device 100x} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the below-described/proposed functions, procedures, and/or methods. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may perform a part or all of processes controlled by the processor(s) 102 or store software code including instructions for performing the below-described/proposed procedures and/or methods. Here, the processor(s) 102 and the memory(s) 104 may be a part of a communication modem/circuit/chip designed to implement wireless communication technology. The transceiver(s) 106 may be connected to the processor(s) 102 and transmit and/or receive radio signals through one or more antennas 108. Each of the transceiver(s) 106 may include a transmitter and/or a receiver. The transceiver(s) 106 is used interchangeably with radio frequency (RF) unit(s). In the present disclosure, the wireless device may represent the communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the afore/below-described/proposed functions, procedures, and/or methods. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may perform a part or all of processes controlled by the processor(s) 202 or store software code including instructions for performing the afore/below-described/proposed procedures and/or methods. Here, the processor(s) 202 and the memory(s) 204 may be a part of a communication modem/circuit/chip designed to implement wireless communication technology. The transceiver(s) 206 may be connected to the processor(s) 202 and transmit and/or receive radio signals through one or more antennas 208. Each of the transceiver(s) 206 may include a transmitter and/or a receiver. The transceiver(s) 206 is used interchangeably with RF unit(s). In the present disclosure, the wireless device may represent the communication modem/circuit/chip.

The wireless communication technology implemented in the wireless devices 100 and 200 of the present disclosure may include narrowband Internet of Things for low-power communication as well as LTE, NR, and 6G communications. For example, NB-IoT technology may be an example of Low Power Wide Area Network (LPWAN) technology, and may be implemented by, but is limited to, standards such as LTE Cat NB1 and/or LTE Cat NB2. Additionally or alternatively, the wireless communication technology implemented in the wireless devices XXX and YYY of the present disclosure may perform communication based on the LTE-M technology. For example, the LTE-M technology may be an example of the LPWAN technology, and may be called by various names such as enhanced machine type communication (eMTC). For example, the LTE-M technology may be implemented by, but is not limited to, at least one of various standards such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M. Additionally or alternatively, the wireless communication technology implemented in the wireless devices XXX and YYY of the present disclosure may include, but is not limited to, at least one of ZigBee, Bluetooth, and Low Power Wide Area Network (LPWAN) considering low-power communication. For example, the ZigBee technology may create personal area networks (PAN) related to small/low-power digital communications based on various standards such as IEEE 802.15.4, and may be called by various names.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as a physical (PHY) layer, medium access control (MAC) layer, a radio link control (RLC) layer, a packet data convergence protocol (PDCP) layer, radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in the present disclosure. The one or more processors 102 and 202 may generate messages, control information, data, or information according to the functions, procedures, proposals, and/or methods disclosed in the present disclosure. The one or more processors 102 and 202 may generate signals (e.g., baseband signals) including PDUs, SDUs, messages, control information, data, or information according to the functions, procedures, proposals, and/or methods disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The functions, procedures, proposals, and/or methods disclosed in the present disclosure may be implemented using firmware or software, and the firmware or software may be configured to include the modules, procedures, or functions. Firmware or software configured to perform the functions, procedures, proposals, and/or methods disclosed in the present disclosure may be included in the one or more processors 102 and 202 or stored in the one or more memories 104 and 204 so as to be driven by the one or more processors 102 and 202. The functions, procedures, proposals, and/or methods disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, commands, and/or instructions. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208. The one or more transceivers 106 and 206 may be configured to transmit and receive user data, control information, and/or radio signals/channels, mentioned in the functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 3 illustrates another example of a wireless device capable of performing implementation(s) of the present disclosure. Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 2. For example, the transceiver(s) 114 may include the one or more transceivers 106 and 206 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast UE, a hologram device, a public safety device, an MTC device, a medicine device, a fintech device (or a finance device), a security device, a climate/environment device, the AI server/device (400 of FIG. 1), the BS (200 of FIG. 1), a network node, etc. The wireless device may be used in a mobile or fixed place according to a use-case/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read-only memory (ROM)), a flash memory, a transitory memory, a non-transitory memory, and/or a combination thereof.

In the present disclosure, the at least one memory (e.g., 104 or 204) may store instructions or programs, and the instructions or programs may cause, when executed, at least one processor operably connected to the at least one memory to perform operations according to some embodiments or implementations of the present disclosure.

In the present disclosure, a computer readable (non-transitory) storage medium may store at least one instruction or program, and the at least one instruction or program may cause, when executed by at least one processor, the at least one processor to perform operations according to some embodiments or implementations of the present disclosure.

In the present disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the present disclosure.

In the present disclosure, a computer program may include program code stored on at least one computer-readable (non-transitory) storage medium and, when executed, configured to perform operations according to some implementations of the present disclosure or cause at least one processor to perform the operations according to some implementations of the present disclosure. The computer program may be provided in the form of a computer program product. The computer program product may include at least one computer-readable (non-transitory) storage medium

A communication device of the present disclosure includes at least one processor; and at least one computer memory operably connected to the at least one processor and configured to store instructions for causing, when executed, the at least one processor to perform operations according to example(s) of the present disclosure described later.

Wireless communication systems are extensively deployed to provide various types of communication services such as voice and data. The demand for higher data rates is increasing to accommodate incoming new services and/or scenarios where the virtual and real worlds blend. To address these ever-growing demands, new communication technologies beyond 5G are required. New communication technologies beyond 6G systems (hereinafter referred to as 6G) aim to achieve (i) extremely high data speeds per device, (ii) very large number of connected devices, (iii) global connectivity, (iv) ultra-low latency, (v) reducing energy consumption of battery-free IoT devices, (vi) ultra-reliable connections, (vii) connected intelligence with machine learning capabilities. In the 6G system, the following technologies are being considered: artificial intelligence (AI), terahertz (THz) communication, optical wireless communication (OWC), free space optics (FSO) backhaul network, massive multiple-input multiple-output (MIMO) technology, blockchain, three-dimensional (3D) networking, quantum communication, unmanned aerial vehicle (UAV), cell-free communication, integration of wireless information and energy transmission, integration of sensing and communication, integration of access backhaul networks, hologram beamforming, big data analysis, large intelligent surface (LIS), and so on.

In particular, there has been a rapid increase in attempts to integrate AI into communication systems. Methods being attempted in relation to AI may be broadly categorized into two: AI for communications (AI4C), which uses AI to enhance communication performance, and communications for AI (C4AI), which develops communication technologies to support AI. In the AI4C field, designs have been attempted to replace the roles of channel encoders/decoders, modulators/demodulators, or channel equalizers with end-to-end autoencoders or neural networks. In the C4AI field, as one type of distributed learning, federated learning involves updating a common prediction model by sharing only the weights and gradients of models with the server without sharing device raw data while protecting privacy.

Introducing AI into communications may simplify and enhance real-time data transmission. AI may use numerous analytics to determine a method of performing complex target tasks. In other words, AI may increase efficiency and reduce processing delays.

Time-consuming tasks such as handover, network selection, and resource scheduling may be instantly performed using AI. AI may also play a significant role in machine-to-machine, machine-to-human, and human-to-machine communications. AI-based communication systems may be supported by meta-materials, intelligent architectures, intelligent networks, intelligent devices, intelligence cognitive radio, self-sustaining wireless networks, and machine learning.

Recent attempts to integrate AI into wireless communication systems have primarily focused on the application layer, network layer, and particularly on wireless resource management and allocation. However, research into integrating AI into wireless communication systems is increasingly evolving towards the MAC layer and the physical layer. In particular, there are emerging attempts to combine deep learning with wireless transmission at the physical layer. AI-based physical layer transmission refers to applying signal processing and communication mechanisms based on AI drivers rather than traditional communication frameworks in fundamental signal processing and communication mechanisms. For example, the AI-based physical layer transmission may include deep learning-based channel coding and decoding, deep learning-based signal estimation and detection, deep learning-based MIMO mechanisms, AI-based resource scheduling and allocation, and the like.

Machine learning may be used for channel estimation and channel tracking. Machine learning can be used for power allocation, interference cancellation, etc. in the DL physical layer. Machine learning may also be used in MIMO systems for antenna selection, power control, and symbol detection.

However, applying deep neural networks for transmission at the physical layer may have the following issues.

Deep learning-based AI algorithms require a large amount of training data to optimize training parameters. However, due to limitations in acquiring data from specific channel environments, a significant amount of training data is often used offline. Static training of training data in specific channel environments may lead to contradictions between the dynamic features and diversity of wireless channels.

Furthermore, current deep learning primarily targets real signals. However, signals at the physical layer of wireless communication are complex signals. More research is needed on neural networks for detecting complex-domain signals to match the characteristics of wireless communication signals.

Hereinafter, machine learning will be described in detail.

Machine learning refers to a series of operations for training machines to perform tasks that are difficult to be performed by human. Machine learning requires data and learning models. In machine learning, data learning methods may be broadly categorized into three types: supervised learning, unsupervised learning, and reinforcement learning.

Neural network learning aims to minimize errors in outputs. Neural network learning refers to a process of repeatedly inputting training data to a neural network, calculating the error of the output and target of the neural network for the training data, backpropagating the error of the neural network from the output layer of the neural network to the input layer to reduce the error, and updating the weight of each neuron of the neural network.

Supervised learning may use training data labeled with a correct answer, whereas unsupervised learning may use training data that is not labeled with a correct answer. For example, in the case of supervised learning for data classification, training data may be labeled with each category. The labeled training data may be input to the neural network, and the output (category) of the neural network may be compared with the label of the training data, thereby calculating the error. The calculated error may be backpropagated through the neural network in reverse (that is, from the output layer to the input layer), and the connection weight(s) of each neuron of each layer of the neural network may be updated based on the backpropagation. Changes in the updated connection weight(s) of each neuron may be determined based on the learning rate. The calculation of the neural network for input data and the backpropagation of the error may configure a learning epoch. The learning data may be applied differently depending on the number of repetitions of the learning epoch of the neural network. For example, in the early phase of learning of the neural network, a high learning rate may be used to increase efficiency such that the neural network rapidly ensures a certain level of performance, but in the late phase of learning, a low learning rate may be used to increase accuracy.

The learning method may vary depending on the feature of data. For example, learning may be performed based on supervised learning rather than unsupervised learning or reinforcement learning to allow a receiver to accurately predict data transmitted from a transmitter in a communication system.

The learning model corresponds to the human brain. To this end, the most basic linear model may be considered. However, a machine learning paradigm that uses highly complex neural network structures such as artificial neural networks as learning models is referred to as deep learning.

Neural network cores used for learning may be broadly categorized into a deep neural network (DNN), a convolutional deep neural network (CNN), and a recurrent neural machine (RNN).

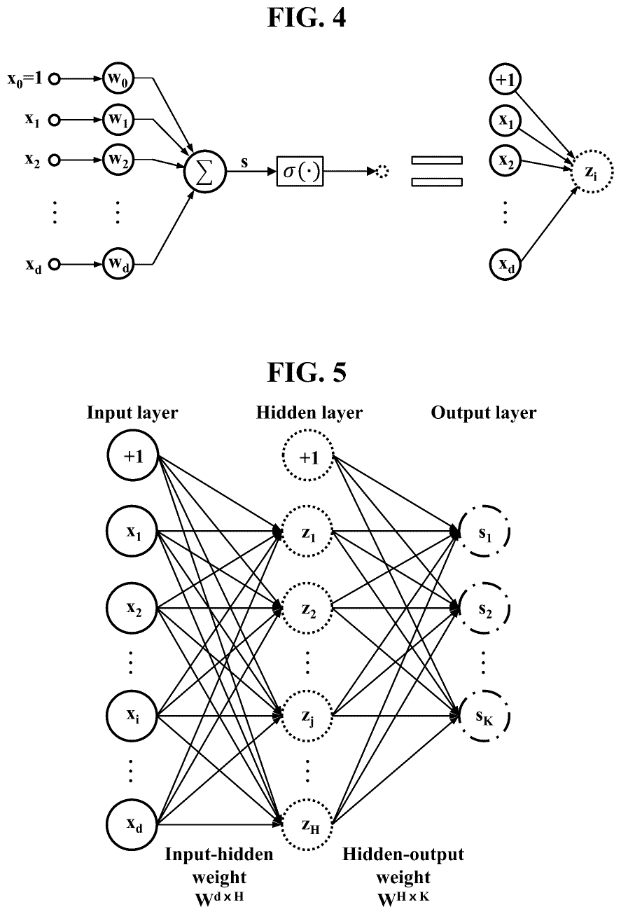

FIG. 4 illustrates a perceptron structure used in an artificial neural network.

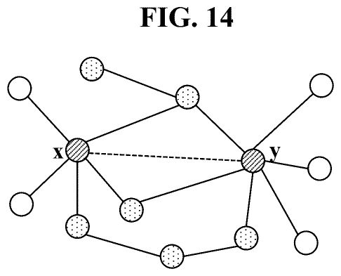

An artificial neural network may be implemented by connecting multiple perceptrons. Referring to FIG. 4, a process of receiving an input vector of x=(x₁, x₂, . . . , x_{d}), multiplying each component by a weight of w=(w₁, w₂, . . . , w_{d}), summing up the results, and then applying an activation function of σ(·) is referred to as a perceptron. For a large artificial neural network structure, the simplified perceptron structure shown in FIG. 14 may be extended. For a large artificial neural network structure, the simplified perceptron structure shown in FIG. 4 may be extended and applied to a multi-dimensional perceptron with different input vectors.

FIG. 5 illustrates a multilayer perceptron structure.

The perceptron structure shown in FIG. 4 may be extended to a multilayer perceptron structure having a total of three layers based on input and output values. An artificial neural network having H perceptrons of (d+1) dimensions between the first and second layers and K perceptrons of (H+1) dimensions between the second and third layers may be represented by the multilayer perceptron structure shown in FIG. 5.

A layer where input vectors are located is called an input layer, a layer where final output value(s) are located is called an output layer, and all layers between the input and output layers are referred to as hidden layers. In the example of FIG. 5, three layers are illustrated. However, since the actual number of layers in an artificial neural network is counted excluding the input layer, the artificial neural network based on the multilayer perceptron structure in FIG. 5 may be considered as having two layers. An artificial neural network is constructed by two-dimensionally connecting perceptrons of basic blocks.

In a neural network, layers are composed of small individual units called neurons. In the neural network, neurons receive inputs from other neurons, perform processing, and produce outputs. A region within the previous layer where each neuron receives inputs is called a receptive field. Each neuron computes output values by applying a specific function to input values received from the receptive field within the previous layer. The specific function applied to the input values is determined by i) a vector of weights and ii) biases. Learning in the neural network is performed based on iterative adjustment of the biases and weights. The vector of weights and the biases are called filters, which represent particular features of the input.

The aforementioned input layer, hidden layer, and output layer may be commonly applied not only to the multilayer perceptron structure but also to various artificial neural network structures such as CNNs, which will be discussed later. As the number of hidden layers increases, the artificial neural network becomes deeper, and the machine learning paradigm that uses sufficiently deep artificial neural networks as learning models is called deep learning. In addition, an artificial neural network used for deep learning are called DNNs.

The aforementioned multilayer perceptron structure is referred to as a fully-connected neural network. In the fully-connected neural network, there are no connections between neurons within the same layer, and connections exist only between neurons in adjacent layers. A DNN, which has the fully-connected neural network structure, includes multiple hidden layers and combinations of activation functions, and thus the DNN may be effectively applied to capture the characteristics of correlation between inputs and outputs. Here, the correlation characteristic may mean the joint probability of inputs and outputs.

On the other hand, various artificial neural network structures distinct from the DNN may be formed depending on how multiple perceptrons are connected to each other.

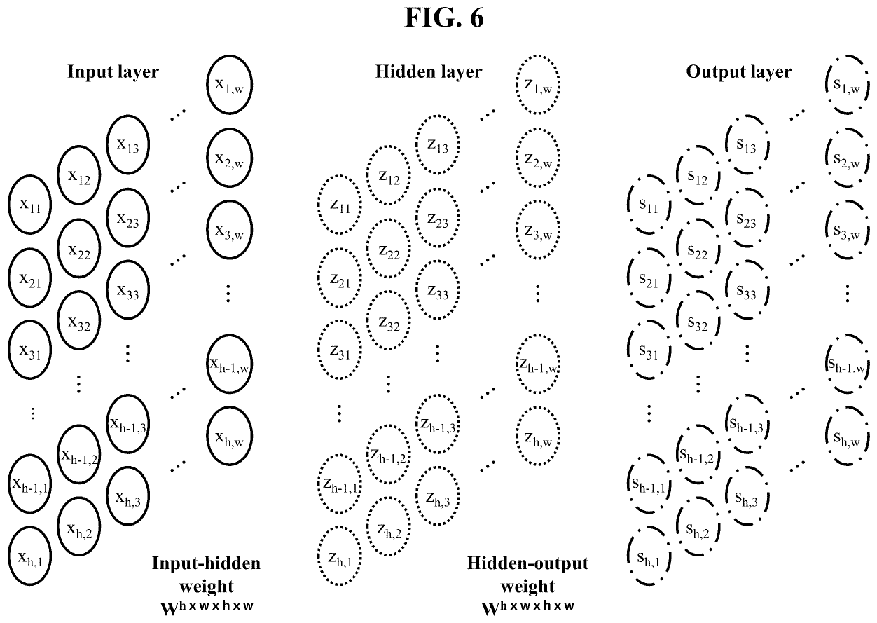

FIG. 6 illustrates the structure of a CNN.

In a DNN, neurons within a layer are arranged in a one-dimensional manner. However, referring to FIG. 6, in the CNN, neurons may be assumed to be arranged in a two-dimensional manner, with w neurons horizontally and h neurons vertically. In this case, since a weight is added for each connection from a single input neuron to hidden layers, a total of h×w weights need to be considered. Since there are h×w neurons in input layers, a total of h²w² weights are required between two adjacent layers.

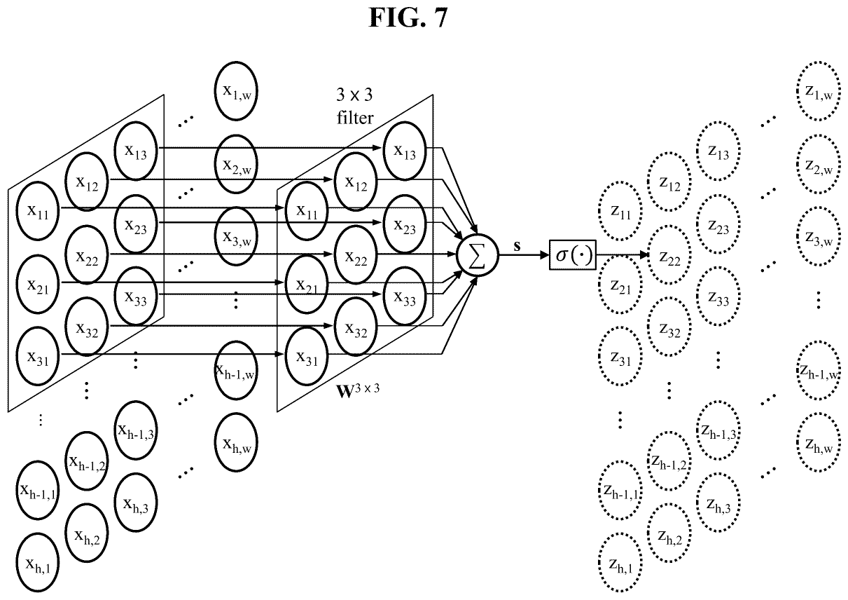

FIG. 7 illustrates a filtering operation in a CNN.

The CNN shown in FIG. 6 faces the issue of an exponential increase in the number of weights depending on the number of connections. Thus, small-sized filters are assumed to exist instead of considering connections between all neurons in adjacent layers. Then, weighted sum and activation function operations are performed on overlapping regions of filter as shown in FIG. 7.

A single filter has weights corresponding to the size of the filter and may undergo learning of the weights such that the filter extracts specific features from an image as factors and produce outputs based on the factors. In FIG. 7, a 3×3 filter is applied to a top-left 3×3 region of an input layer, and an output value obtained by performing the weighted sum and activation function operations on related neurons is stored in z₂₂.

The filter scans the input layer, performs the weighted sum and activation function operations while moving horizontally and vertically at regular intervals, and places the output value at the current position of the filter. This operation method is similar to a convolution operation on images in the field of computer vision. Thus, a DNN with such a structure is called a CNN, and a hidden layer generated by the convolution operation is referred to as a convolutional layer. In addition, a neural network with multiple convolutional layers is called a deep convolutional neural network (DCNN).

In the convolutional layer, the weighted sum is calculated by considering only neuron(s) located within a region covered by the current filter, thereby reducing the number of weights. As a result, a single filter may focus on features within a local region. Therefore, the CNN may be effectively applied to process image data where a physical distance in two-dimensional space is an important criterion. In the CNN, multiple filters may be applied immediately before the convolutional layer, and multiple output results may be produced by convolution operations of each filter

The CNN may be divided into a part for extracting features from data and a part for classifying classes. In the CNN, the part for extracting features from data (hereinafter referred to as a feature extraction region) may be structured by stacking the following layers multiple times: an essential convolutional layer and an optional pooling layer. As the final part of the CNN, a fully connected layer for classifying classes is added. There is a flattening layer that converts image-type data into an array format between the part for extracting features from data and the part for classifying data.

As described above, the convolutional layer applies filters to input data and then incorporates the activation function, and the pooling layer is positioned after the convolutional layer. In the CNN, filters are also referred to as kernels. In the CNN, the filter performs the convolution operation by traversing the input data at specified intervals. The filter applied in the convolutional layer may create a feature map by moving at the specified intervals and performing the convolution operation on the entirety of the input data. For example, referring to FIG. 7, the output values: z₁₁ to z_{h,w} may constitute the feature map. If multiple filters are applied to the convolutional layer, the convolution operation is performed for each filter, and the feature map may be created based on the sum of convolutions from the multiple filters. The feature map is also referred to as an activation map. In other words, the CNN consist of an input layer, hidden layers, and an output layer. In the CNN, the hidden layers include layers performing convolutions. Typically, the layer performing the convolution computes a dot product between a convolution kernel and the input matrix of the layer, and the activation function of the layer is commonly a rectified linear unit (ReLU). As the convolutional kernel slides over the input matrix of the layer, the convolution operation creates a feature map that contributes to the input of the next layer.

The pooling layer uses output data from the convolutional layer (e.g., feature map) as input data and reduces the size of the input data or emphasizes specific data. In the pooling layer, the following methods are used to process data: max pooling, which collects the maximum value of values within a specific region of a square matrix; average pooling, which calculates the average of values within a specific region of a square matrix; and min pooling, which determines the minimum value of values within a specific region of a square matrix.

The fully connected layer connects every neuron in one layer to every neuron in another layer.

Shannon established the basis for a mathematical theory of communication, deriving conditions that enable reliable transmission of sequences of symbols over noise channels. A demand for a higher data rate has increased to accommodate new incoming services and/or scenarios in which the virtual and real worlds mix. According to current trends, a bottleneck is expected to occur in the near future due to shortages of resources such as spectrum and energy. For example, when a carrier frequency increases, more spaces for a wider bandwidth is generated, but undesirable phenomena such as blocking, atmospheric absorption, and reduced power efficiency may also occur. The following three levels of communication, identified by Shannon and Weaver, have been considered to deal with the challenges posed by these never-ending demands: (i) transmission of symbols (technical issues); (ii) semantic exchange of transmitted symbols (semantic issues); and (iii) effectiveness of semantic information exchange (effectiveness issues).

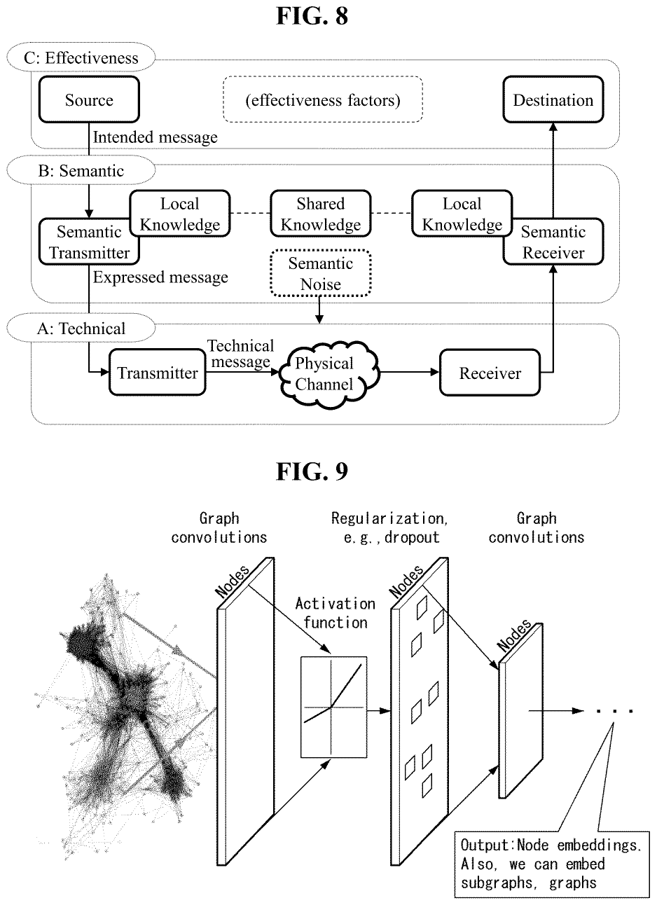

FIG. 8 illustrates a three-level communication model to which implementations of the present disclosure are applicable.

Referring to FIG. 8, the communication model may be defined at three levels A to C. Level A relates to how accurately symbols (technical messages) are to be transmitted between a transmitter and a receiver. The level A may be considered when the communication model is understood from a technical aspect. Level B relates to how accurately the symbols transmitted between a telegraph and a receiver convey the meaning. The level B may be considered when the communication model is understood from a semantic aspect. Level C relates to how effectively the meaning received at a destination contributes to subsequent operations. The level C may be considered when the communication model is understood in terms of effectiveness.

Shannon focused on technical issues and did not consider communication from a semantic aspect. In contrast, Weaver explained that the information theory of Shannon is to be extended to consider the levels B and C, including adding semantic transmitters, semantic receivers, and semantic noise to the communication model of Shannon.

Until 5G communication, technology development was developed focusing only on the level A (i.e., symbol level) for exchanging data. Communication technology research focused on the level A has allowed derivation of a mathematical theory of communication based on probabilistic models. However, for recent networks that emphasize effectiveness and sustainability while enabling pervasive intelligent services, it is no longer justifiable to assume that semantics are irrelevant. In addition to a transmission method, what to transmit also needs to be studied.

Therefore, to respond to a growing need for higher data rates to accommodate new emerging services such as virtual reality or autonomous driving within limited resources such as spectrum and energy, communication model of the level B as well as the level A (the level C) may be considered. In the communication model of the level B, a transmitter and a receiver may be referred to as a semantic transmitter and a semantic receiver, respectively, and semantic noise may be additionally considered.

One of the various goals of 6G communications is to enable a variety of new services that connect machines to people with various levels of intelligence. Not only existing technical issues (e.g., level A in FIG. 8) but also semantic issues (e.g., level B in FIG. 8) need to be considered.

To facilitate understanding, semantic communication is briefly explained below using communication between people as an example. Words for exchanging information (i.e., word information) relate to “meaning.” After hearing what a speaker says, a listener may interpret the meaning or concept expressed by words of the speaker. When this is connected to the communication model of FIG. 8, to support semantic communication, a concept related to a message transmitted from a source need to be correctly interpreted at a destination. The communication model at the semantic level (e.g., refer to the level B in FIG. 8) may provide improved performance compared with the communication model of the existing technical level (e.g., refer to the level A in FIG. 8). One of the main reasons such performance improvements is provided is that knowledge sharing between a source and a destination is used. This knowledge may be a language including logical rules and entities that allow a receiver to correct errors that occur at a symbolic level.

One effect of semantic communication is to compress the amount of data information and apply the same to communication. As a metaphor, for example, if a parent and a child walk together on a street when a car approaches and the child runs into a roadway, the parent may only shout “Hey” in an urgent voice. The urgent cry of “Hey” by the parent is conveyed to the child by combining the tone of voice and the name, and the child recognizes the meaning of the cry of “Hey” as a dangerous situation that the parent has educated about in advance. In other words, the meaning that the parents want to convey is conveyed to the child based on the knowledge shared in advance without having to convey a lot of information. At an effectiveness level, the goal of safety is achieved.

For success of communication at the basic technical level, the case in which an error occurs in data or the case an error does not occur may be primarily considered through cyclic redundancy check (CRC). However, the semantic level communication evaluates a degree by which the meaning that a transmitter wants to convey and the meaning interpreted by a receiver are similar. The similarity between the meaning intended by the transmitter and the meaning understood by the receiver is mainly evaluated by a semantic similarity function.

As described above, semantics (i.e., meaning) is related to knowledge, and thus a method of representing knowledge is needed to process a semantic message. Graph-based knowledge representation may be considered as such a method of representing knowledge. In the graph-based knowledge representation, knowledge may be represented by a graph containing a node (or vertex) and a link (or edge). Here, the node is related to an entity, and the link represents a relation between entities.

Compared to table-based databases, graph-based knowledge representation has an advantage that data having a new relation with existing data may be easily added, deleted, or changed.

Shared knowledge may be generated based on a graph generated to represent knowledge. For example, the following operation may be performed for graph-based knowledge representation. Referring to FIG. 8, a graph corresponding to local knowledge possessed by a source and a destination may be shared with each other, thereby generating shared knowledge. Based on the shared knowledge, the interpretation accuracy of a concept (e.g., semantic message) transmitted between the source and the destination may be improved. Therefore, normal semantic communication may be performed through the shared knowledge.

However, the size of graph-based knowledge (i.e., graph-based information) for generating shared knowledge may be very large. When the size of the graph-based knowledge is excessively large, consumption of resources required to transmit the graph-based knowledge is large, and the amount of computation required to compare the graph-based knowledge transmitted/received between a transmitter (e.g., source) and a receiver (e.g., destination) also increases significantly, and accordingly, the graph-based knowledge may not help concepts transmitted through semantic communication be interpreted correctly.

Artificial intelligence (AI)/machine learning (ML) technology may be used to effectively resolve the above-described problems. For example, a graph neural network (GNN) may be used.

FIG. 9 illustrates an operation of a graph neural network (GNN). For some details about GNN, “http:/web.stanford.edu/class/cs224w/slides/06-GNN1.pdf” may be referenced.

The GNN is a neural network to be directly applied to a graph. Images are basically arrays/matrices of pixel values. An algorithm of the GNN may classify pictures based on those values. The entire array is transformed through a number of operations to preserve important information (e.g., what value a pixel has and how the value relate to neighboring values) and may be finally passed to a fully connected neural network to weight relations between pixels. Pixel values of each image may be represented as vectors before arrays (or more accurately, stacked arrays (tensors)) are passed to the fully connected neural network. However, graphs do not have a natural order or a reference point, and thus it is not easy to make the graphs into vectors, unlike a picture including regular grids. Finding vectors for nodes may be obtained by node representation learning. The result of such representation learning is node embedding. Embedding may refer to the result of converting a graph into a vector that a machine is capable of understanding, or may refer to the entire series of processes. Referring to FIG. 9, the purpose of deep graph encoding is to pass the received graph through the DNN to obtain a node (i.e., vertex)/subgraph/graph embeddings to be used for any prediction task.

The embedding result obtained through the GNN is learned such that similarity between nodes/subgraphs/graphs of an original graph and similarity between nodes/subgraphs/graphs embedded in an embedding space are as equal as possible. In this case, a similarity function may be used. The similarity function is used to determine how a relation in an input network is mapped to a relation in the embedding space. There is no limit to a type of similarity function. For example, the similarity function used in the GNN may be based on one or a combination of existing similarity functions implemented in various ways. For example, similarity calculation models illustrated in the following table may be implemented as a DNN and used to determine similarity in some implementations of the present disclosure.

TABLE 1

| Model | Main concept |
|---|---|
| Distance model | A similarity-based distance (e.g., Euclidean distance/Manhattan |
| | distance) is calculated. |
| | For example, in a method of calculating a distance using an absolute |
| | value, a distance L1 between two entities (e.g., Manhattan distance) in a space |
| | called a relation is calculated as a score: |
| | $g ( {e}_{1} , R , {e}_{2} ) = ‖ {W}_{R , 1} {e}_{1} - {W}_{R , 2} {e}_{2} ‖ ,$ |
| | where W is a parameter for classifying the relation R. |
| Single layer | A weight parameter W and an input variable X that are used in a |
| model: | single layer are calculated. A non-linear activation function f is used. |
| perceptron model | $g ( {e}_{1} , R , {e}_{2} ) = {u}_{R}^{T} f ( {W}_{R , 1} {e}_{1} + {W}_{R , 2} {e}_{2} ) = {u}_{R}^{T} f ( [ {W}_{R , 1} , {W}_{R , 2} ] [ \begin{matrix}{e}_{1} \\ {e}_{2}\end{matrix} ]$ |
| | Here, f is, for example, a hyperbolic tangent function for non- |
| | linearity, and W and u are parameters for calculating a score for the |
| | relation R. |
| | The above equation is a combination (+) of two entity vectors, with |
| | non-linearity added. |
| Hadamard model | The Hadamard product is used to increase the strength of interaction |
| | between an entity and a relation. |
| | $g ( {e}_{1} , R , {e}_{2} ) = {( {W}_{1} {e}_{1} ⊗ {W}_{rel , 1} {e}_{R} + {b}_{1} )}^{T} ( {W}_{2} {e}_{2} ⊗ {W}_{rel , 2} {e}_{R} + {b}_{2} )$ |
| | For each entity, through the Hadamard product, interaction with the |
| | relations is calculated → the score for the relation between entity 1 e₁ and |
| | entity 2 e₂ is calculated. |
| | All relations share characteristics through parameters W₁, W₂, Wᵣₑₗ. |
| | Here, Wᵣₑₗ is a weight vector for the relation, and e_{R} is a vector |
| | representing the relation between entities. |
| Bilinear model | To connect two vector spaces, the two vector spaces are expressed as |
| | one vector space. This simply means combining two vector inputs into one |
| | vector output. |
| | When representing an entity and a relation as e and R, respectively, |
| | it may be possible to represent an interaction between entities e for each |
| | relation R in a relation specific bilinear form. |
| | $g ( {e}_{1} , R , {e}_{2} ) = {e}_{1}^{T} {W}_{R} {e}_{2}$ |
| | Generation of a bilinear form means performing some kind of |
| | representation. |

In Table 1, eᵢ represents an entity i that needs to be compared, and may be represented in the form of vector. In Table 1, R represents a relation between entities, and respective parameter W and biases b for the models in Table 1 may be obtained through DNN learning. Table 1 is only an example, and similarity scores may be obtained using various other methods.

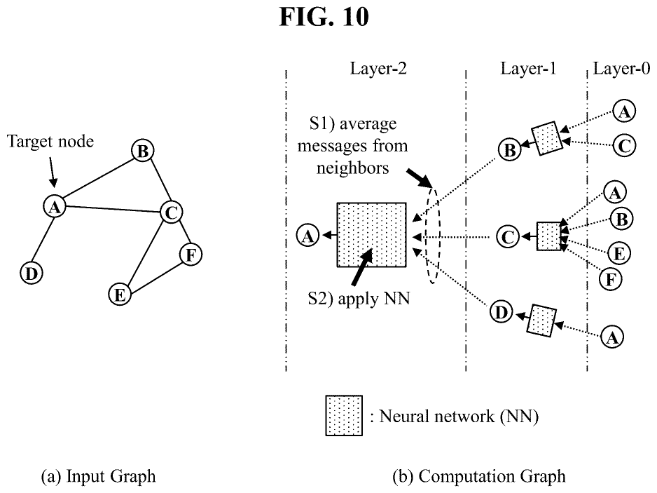

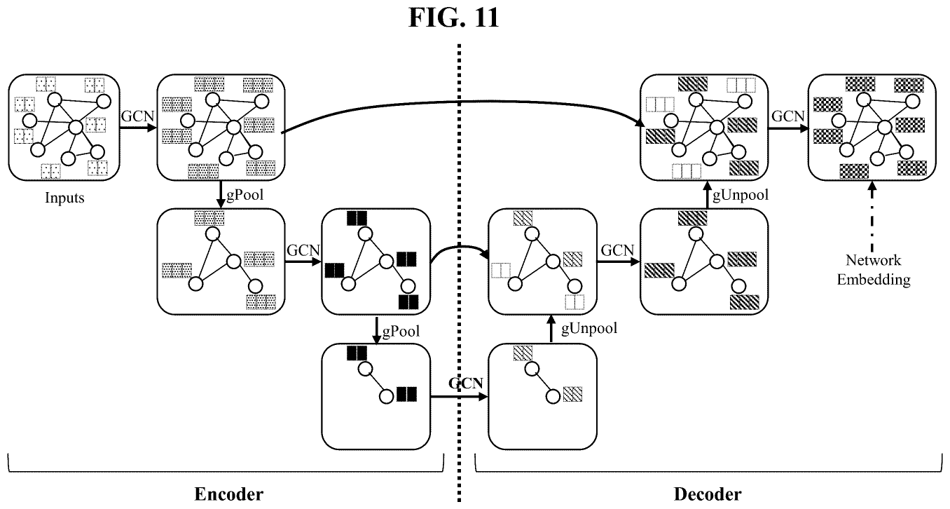

FIG. 10 illustrates a GNN model for a target node.

In the GNN model, a neighborhood aggregation function may be defined to obtain information about a target node and neighboring nodes, and a loss function for embedding may be defined. The loss function represents a difference between a predicted value of a model calculated based on data and an actual value, and is an indicator expressing the ‘poorness’ of model performance. In other words, the loss function indicates how poorly the current model processes data (e.g., graph data). As a value of the loss function is closer to 0, the accuracy of the model may be increased. A loss may vary depending on a task. In the GNN model, a set of nodes for a graph (i.e., a batch of computational graphs) may be learned by applying a neural network, and embeddings for nodes (latent vectors) may be generated as needed. Embeddings may also be generated for nodes that have never been trained. The same aggregation parameters may be shared for all nodes.

Referring to FIG. 10, node embedding is performed based on local network neighborhood information. For example, node B obtains information from nodes A and C, and node A obtains information from nodes B, C, and D (S1). Each NN aggregates neighborhood information. The GNN may average information from neighborhood (S1) and then apply a neural network (S2).

A depth of the GNN model may be freely configured. A node has an embedding value at each layer, and embedding at layer-k has a value for information to be transmitted k times starting from layer-0 and passing through a hidden layer. That is, in a GNN layer, a node aggregates messages from a neighborhood thereof and the node to generate embeddings and transmits the embeddings to generate the embedding of a final target node.

In the GNN model, the parameters of the NN are shared, and thus the learned model may be applied to graphs that are completely different from a graph used for learning.

When GNN is used for semantic communication, GNN-based semantic communication may represent knowledge used in semantic communication as a graph and may form and transmit the latent vector using the GNN rather than transmitting the entire graph data, thereby reducing required resource consumption. The prediction task that the GNN intends to perform using the latent vector may be seen as a task of interpreting a concept received through semantic communication. Therefore, the GNN may be usefully used in semantic communication that operates based on graph data.

A graph pooling scheme is very important in obtaining representation through reduced graphs and graph-level embeddings for a graph structure input with a size and topology changed, and may reduce the number of learning parameters, thereby preventing overfitting. This scheme may help generate latent vectors by combining the CNN structure used in image processing with a graph convolution network (GCN) structure, which is an extension of a graph. The pooling scheme may be performed through an operation such as mean/max/sum. However, in the case of global pooling, which applies such graph pooling to the entire graph, a problem arises in which node embedding information corresponding to a node in the graph may be lost.

For example, when one-dimensional node embedding is applied to two graphs G₁ and G₂, if G₁ and G₂ are given as follows, G₁ and G₂ have different node embeddings, and thus the structures of the respective graphs may be stated to be different: G₁={−1, −2, 0, 1, 2}, G₂={−10, −20, 0, 10, 20}. In this case, when global pooling is performed on each of G₁ and G₂, predicted values ŷ_{G}_{₁} and ŷ_{G}_{₂} for G₁ and G₂ may be as follows: ŷ_{G}_{₁}=sum({−1, −2, 0, 1, 2})=0, ŷ_{G}_{₂}=sum({−10, −20, 0, 10, 20})=0.

The predicted values ŷ_{G}_{₁} and ŷ_{G}_{₂} for G₁ and G₂ may be be considered to correspond to final latent vectors of the graph to be obtained. If the result of performing sum pooling on all nodes for each of G₁ and G₂ is the same as ŷ_{G}_{₁}=0 and ŷ_{G}_{₂}=0, it is not possible to distinguish between G₁ and G₂, and thus a problem arises in which graph data is not capable of being updated through comparison between latent vectors. To resolve this problem, hierarchical pooling (i.e., local pooling) may be applied. When hierarchical pooling is applied, the problem of losing node embedding information may be resolved. For example, when aggregation is performed on G₁ and G₂, ReLU(Sum(−)) is used, and the method below may be applied. Here, ReLU is a unit (f(x)=max (0, x)) that outputs 0 when an input value is less than 0 and outputs an input value as is when the input value is greater than 0.
1) First two nodes and the remaining three nodes are separately aggregated.
2) Aggregation is performed for final prediction.

When methods 1) and 2) above are performed for G₁ and G₂, respectively, pooling for G1 and G2 may proceed as follows.
1) Local pooling for G₁ is performed.
   Round1: ŷₐ=ReLU(sum({−1,−2}))=0, ŷ_{b}=ReLU(sum({0, 1, 2})))=3
   Round2: ŷ_{G}_{₁}=ReLU(sum({ŷₐ,ŷ_{b}})=3
2) Local pooling for G₂ is performed.
   Round1: ŷₐ=ReLU(sum({−10, −20}))=0, ŷ_{b}=ReLU(sum({0, 10, 20})))=30
   Round2: ŷ_{G}_{₁}=ReLU(sum({ŷₐ,ŷ_{b}})=30

As shown in the results above, G₁ and G₂ may be distinguished through final latent vectors ŷ_{G}_{₁} and ŷ_{G}_{₂}. Therefore, it is necessary to use a method of operating a GNN model without losing as much information in a graph as possible through a GNN model that uses a pooling scheme in a hierarchical structure.

In contrast to graph pooling, graph un-pooling is a method in which up-sampling is performed to restore a reduced graph (e.g., feature map, or latent vector of subgraph) obtained through graph pooling to an original graph. The hierarchical structure needs to also be applied to the graph un-pooling scheme. The GNN model to which these graph pooling and graph un-pooling schemes is an end-to-end model and may perform the same function as an encoder-decoder structure of a communication network. There is a specific need to a method of introducing a GNN model with a hierarchical structure suitable for semantic communication corresponding to such a communication network according to a communication level and operating the GNN model.

Even if the above-mentioned GNN and graph pooling-related schemes are appropriately introduced for semantic communication, a process of generating a latent vector for the entire graph data and restoring the latent vector to graph data involves many operations, and thus there may be a possibility that much information is not shared in terms of knowledge sharing. To resolve this problem, it is necessary to extract subgraphs from a graph for knowledge representation, generate latent vectors corresponding to the subgraphs, and then transmit the latent vectors wirelessly, and there is a need for a method of operating the same.

Applying the received latent vectors to the prediction task of the GNN structure may be seen as interpreting a concept represented as a latent vector using a graph corresponding to local knowledge held by a source and a destination, respectively, and but the local knowledge held by a source and a destination, respectively may not match each other, which causes meaning errors (i.e., semantic errors) when interpreting the transmitted concept. When the local knowledge respectively held by the source and the destination are not updated, semantic errors may continue to occur, which may continue to be a problem for the destination to correctly interpret the transmitted concept. To resolve this, it is necessary to increase the similarity of local knowledge between the source and the destination to make interpretation of concepts transmitted by both sides (i.e., to reduce semantic errors in interpretation) by periodically updating graph data corresponding to local knowledge held by the source and the destination through comparison between latent vectors generated after the received latent vectors and subgraphs, and there is a need for a method of operating the same.

In some implementations of the present disclosure, a semantic communication system in which knowledge representation is performed using graph data is assumed. Hereinafter, method(s) and process(s) for increasing similarity between local knowledge of the source and the destination to make interpretation of the transmitted concept accurate by appropriately introducing a GNN related to the subgraph extraction and pooling scheme to the semantic communication system to make a semantic encoder and a semantic decoder operate based on graph data and to update graph data based on periodic transmission of the corresponding graph data will be described.

Hereinafter, in particular, implementations of a semantic level corresponding to level B in FIG. 8 are described. Each of the source and the destination may have a knowledge representation as a graph.

FIG. 11 illustrates an encoder-decoder structure that introduces a pooling-based GNN to semantic communication.

Referring to FIG. 11, the overall flow of semantic communication is as follows. First, an encoder side may obtain final latent vector(s) by repeatedly performing a function of aggregating features from each node to extract a feature map, reducing the size of a graph, and encoding the feature(s) in a manner of grouping encoding blocks into encoding block units and stacking the encoding blocks. A decoder side may obtain a graph corresponding to output of the encoder by repeatedly performing a function of restoring a graph size at a corresponding layer of the encoder and aggregating neighborhood node information in a manner of grouping decoding blocks into decoding block units and stacking the decoding blocks. An encoder block and a decoder block have a functionally symmetrical structure, and thus both the encoder and the decoder need to be configured in a structure in which the same number of encoder blocks and decoder blocks are stacked. Like a skip-connection structure, the encoder side may transfer a feature map extracted from each layer of the encoder and spatial information of a pooling operation (e.g., selected node index information) to the decoder side to improve up-sampling operation performance of the decoder.

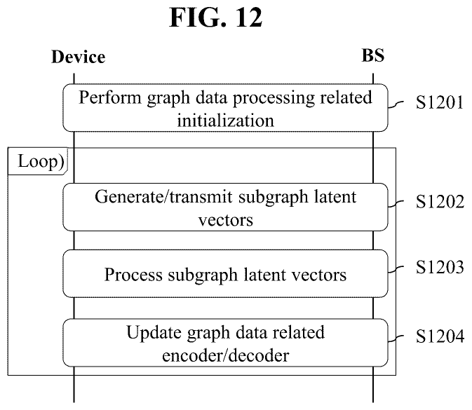

FIG. 12 illustrates a process of updating graph data in a GNN that utilizes a pooling scheme for semantic communication in some implementations of the present disclosure. In FIG. 6, a BS may be a server or another device.

Referring to FIG. 12, a process of updating graph data of the GNN in some implementations of the present disclosure may include performing initialization related to graph data processing (S1201). In an example of FIG. 12, a source from among the device and the BS may generate and/or transmit latent vector(s) of the subgraph (S1202). For example, the device/BS may extract subgraph(s) from the entire graph data and generate the latent vector(s) from the subgraph(s). Information including the generated latent vectors may be transferred between the device and the BS.

The destination from among the device and the BS may process the latent vector(s) of the subgraph received from the source (S1203). For example, the device may calculate the similarity between the latent vector(s) generated by the device and the latent vector(s) received from the BS, and the BS may calculate the similarity between the latent vector(s) generated by the BS and the latent vector(s) received from the device. The device and the BS may update the encoder/decoder related to graph data (S1204). In FIG. 12, S1202 to S1204 may be performed repeatedly until graph data updating is stopped.

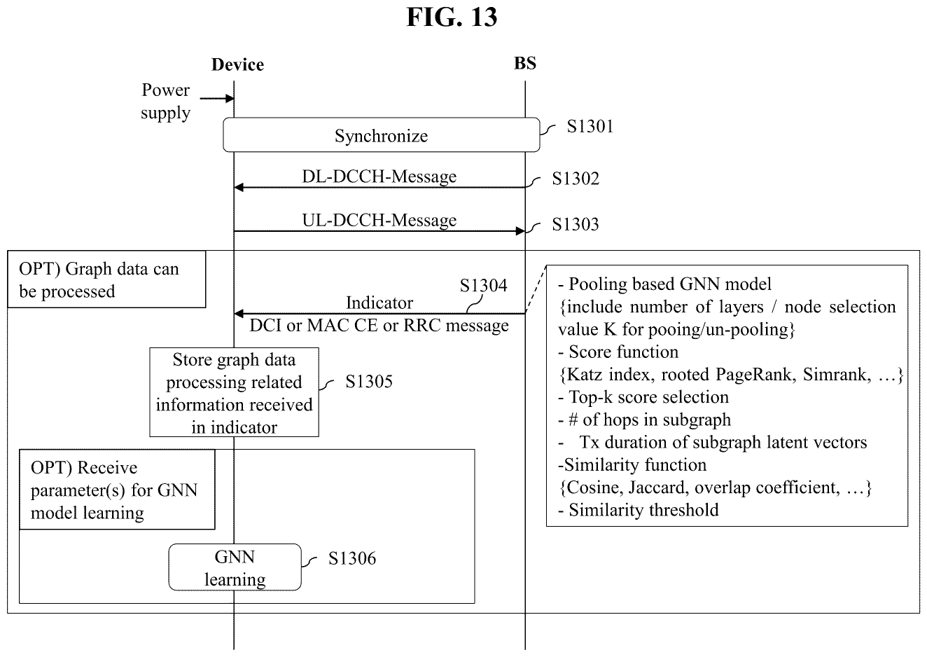

FIG. 13 illustrates a flow of initialization related to graph data processing for semantic communication in several implementations of the present disclosure. In FIG. 13, a BS may be a server or another device.

The BS may configure graph data operation-related information in subgraph units to the device only when it is possible to generate/process graph data by checking the capability of the device.

Referring to FIG. 13, a powered device performs synchronization with the BS (S1301). For example, the device receives a synchronization signal from the BS to synchronize time/frequency with the BS and obtain system information. The device may establish a radio resource control (RRC) connection with the BS by performing a random access process based on the system information.

The BS may transmit a UE capability enquiry to the device (e.g., UE) through a downlink (DL) dedicated control channel (DCCH) message (S1302). The UE capability enquiry may include an inquiry regarding presence or absence of generation/processing of graph data.

The device may provide UE capability information to the BS through an uplink (UL) DCCH message (S1303). The UE capability information may include whether the device is capable of generating/processing graph data and computing capabilities of the device.

The BS may check the capability of the device, and when the device has capability of processing graph data, the BS may transfer an indicator related to initialization of graph data to the device (S1304). The indicator may be transmitted through DCI, a medium access control (MAC) control element (CE), or an RRC message. The indicator may include graph data processing-related information. The graph data processing-related information may include at least one of the following information i to vi.

i) Pooling-based GNN model: This is a model for restoring a subgraph to an input subgraph through a GNN+pooling scheme to add/modify a node/edge after generating a latent vector by mapping the input subgraph to a d-dimensional embedding space by using the same method as the GNN+pooling scheme in the source and the destination, receiving a latent vector of the subgraph, and comparing the generated latent vector with the received latent vector. According to the model, the BS may transfer to the device that pre-learning is completed in the BS (for coarse tuning), or transfer the GNN model parameter(s) to the device (for fine tuning) to allow the device receiving the information to perform leaning by using the corresponding parameter(s). The corresponding parameter(s) may include number of GNN+pooling layers (i.e., number of encoding blocks)/number of GNN+un-pooling layers (i.e., number of decoding blocks). In this case, the number of GNN+pooling layers (i.e., the number of encoding blocks) and the number of GNN+un-pooling layers are the same. The corresponding parameters may include the top n or nodes with the top n % ratio according to importance from among nodes in a graph in the pooling/un-pooling operation as the number of selected nodes.

ii) Score function: Both sides equally need a function for evaluating score values of reference nodes to find and extract a local network (e.g., subgraph data) suitable for a graph network (e.g., graph data) currently configured for knowledge representation. FIG. 14 illustrates a node pair and an edge to which a score function is applied in several implementations of the present disclosure. In FIG. 14, the node pair to which the score function is applied is indicated with a hatched pattern, and the edge connecting nodes of the node pair is indicated with dotted lines. Referring to FIG. 14, the score function may be used to calculate a score between nodes x and y for a set including arbitrary nodes x and y and an edge connecting the nodes.

The following table illustrates representative heuristics.

TABLE 2

| Name | Formula | Order |
|---|---|---|
| Common | \|Γ(x) ∩ Γ(y)\| | first |
| neighbours | | |
| Jaccard | $\vert \frac{Γ ( x ) ⋂ Γ ( y )}{Γ ( x ) ⋃ Γ ( y )} \vert$ | first |
| Preferential | \|Γ(x)\| · \|Γ(y)\| | first |
| attachment | | |
| Adamic-Adar | ${\sum }_{z ∈ Γ ( x ) ⋂ Γ ( y )} \frac{1}{log \vert Γ ( z ) \vert}$ | second |
| Resource allocation | ${\sum }_{z ∈ Γ ( x ) ⋂ Γ ( y )} \frac{1}{\vert Γ ( z ) \vert}$ | second |
| Katz | ${\sum }_{l = 1}^{∞} {β}^{l} \vert path ( x , y ) = l \vert$ | high |
| PageRank | ${q}_{xy} + {q}_{yx}$ | high |
| SimRank | $γ \frac{{\sum }_{a ∈ \vert Γ ( x ) \vert} {\sum }_{b ∈ \vert Γ ( y ) \vert} score ( a , b )}{\vert Γ ( x ) \vert \cdot \vert Γ ( y ) \vert}$ | high |
| Resistance distance | $\frac{1}{{l}_{xx}^{+} + {l}_{yy}^{+} - 2 {l}_{xy}^{+}}$ | high |

In Table 2, Γ(x) represents a set of neighborhood of vertex x, |path(x, y)=I| counts the number of length-l paths between x and y, and q_{xy} is a stationary distribution probability of y under a random walk from x with restart. The SimRank score is recursive definition, and

$${l}_{xy}^{+}$$

is an entry (x, y) in pseudoinverse of the Laplacian matrix of the graph.

From among the heuristics illustrated in Table 2, Katz index, rooted PageRank, and SimRank, which use high-order heuristics, (e.g., graph structure features) that consider the overall structure of a network may be considered as score functions. The corresponding heuristics may be well approximated from local subgraphs by using γ-decaying heuristic theory (refer to “Muhan Zhang, Yixin Chen, “Link Prediction Based on Graph Neural Networks”, and NeurIPS 2018”). The higher-order heuristics may have much higher performance than first-order and second-order heuristics, most of the higher-order heuristics may be unified by the γ-decaying heuristic theory, and any γ-decaying heuristic may be effectively approximated from an h-hopping enclosing subgraph, and in this case, an approximation error decreases exponentially at least to h. This means that small h may be used to learn good higher-order features. This also implies that an effective order of these higher-order heuristics is not very high. Therefore, even if the device and the BS learn a high-order graph structure from a subgraph extracted based on a small number of hops, the device and the BS may have an amount of information that sufficiently reflects the information of the entire network. Based on this fact, when the BS transmits content related to the reference score function to the device, one of the score functions corresponding to higher-order heuristics may be selected and content related to the selected the score function may be transmitted to the device.

iii) Top-K score selection: The device may rank a set of node pairs and edges between nodes based on the scores obtained through the score function, and then selects the top-K score sets. The device determines the number of subgraphs to be exchanged between the source and the destination according to the configured number K.

iv) Number of hops for subgraph: This is information about how far neighborhood nodes are from each node in a set of node pairs and edges selected through information iii to be configured as a subgraph. According to the γ-decaying heuristic theory mentioned in information ii, a small number of hops (first-order hop or second-order hop) may be configured as hop for the subgraph.

v) Transmission cycle of latent vector(s) of subgraph: A transmission cycle of the corresponding latent vectors may be configured considering the amount of computation between the device and the BS, wireless link information, and the like, a latent vector may be generated through down-sampling (with pooling) according to the corresponding transmission cycle, comparison of similarity between latent vectors may be performed, and a process of restoring an input subgraph through un-pooling of the corresponding latent vector (with un-pooling) may be performed.

vi) Similarity function/similarity threshold: The device and the BS may calculate the similarity between the transferred latent vector (i.e. the generated latent vector) and the received latent vector through the similarity function, and determine whether the two latent vectors are similar based on a threshold. The same function as the function used in ii) may be used as the similarity function (in this case, the latent vectors correspond to latent vectors respectively received by the nodes x and y illustrated in ii) and the generated latent vector), or a new function is configured and similarity may be measured. When the calculated similarity value is low compared to the similarity threshold, a GNN+un-pooling operation is performed at a receiving end to restore the input subgraph. Graph data update needs to performed after comparison is performed using the same reference function and threshold value at the source and destination, and thus the similarity function and the similarity threshold are transferred from the BS to the device.

The device stores the transferred data processing-related information (S1305). Accordingly, the transferred data processing-related information has the same value for the device and the BS.

When the device receives parameter(s) for GNN model learning, the device may perform GNN learning (S1306).

In some implementations of the present disclosure, some operations shown in the example of FIG. 13 may be omitted depending on the situation and/or settings.

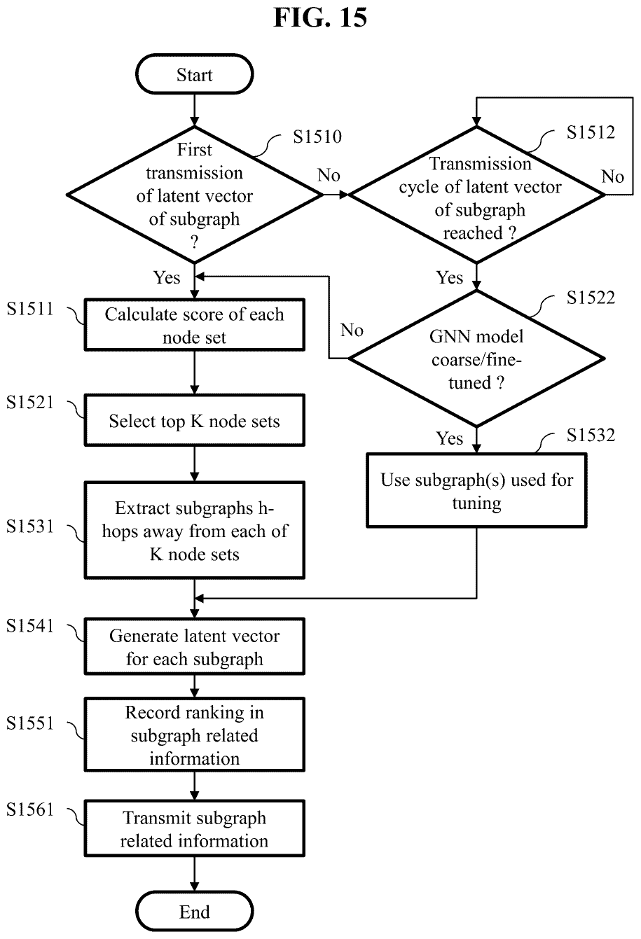

Operations of FIGS. 15 to 19 may be performed at each of a source and a destination, and may be performed according to a configured cycle. For convenience of explanation, in the operations of FIGS. 15 to 19, the source and the destination may each be referred to as a device, and implementations of the present disclosure are described.

FIG. 15 illustrates a process related to extraction of a subgraph and related to generation/storage/transmission of related information according to some implementations of the present disclosure. In particular, FIG. 15 is a flowchart showing operation S1202 of extracting a subgraph and generating/transmitting a latent vector in the example of FIG. 12.

The device generates related latent vectors using subgraph data as input to a GNN model using a pooling scheme after extracting a subgraph from graph data according to a configured cycle, and stores information obtained while performing a GNN model (e.g., a feature map obtained during an encoding block operation or an index of a selected node). After an operation of a GNN system using the pooling scheme is completed, the device wirelessly transmits the obtained information. When the corresponding operation is performed after the GNN model is coarse-tuned/fine-tuned, the device stores information obtained during an inference operation of the GNN model on which generation of latent vectors and/or learning are completed using subgraphs used for the coarse/fine tuning. The corresponding operation may be seen as an operation performed by a semantic encoder in semantic communication at level B in FIG. 8.

Referring to FIG. 15, when the latent vector of the subgraph is not transmitted for the first time (No in S1510), a transmission cycle of the subgraph is reached (Yes in S1512), the GNN model is not coarse/fine-tuned (No in S1522), or the latent vector of the subgraph is transmitted for the first time (Yes in S1510), the device may calculate a score of each node set by using the configured score function (S1511) and select the top K node sets as a reference for extracting the subgraph (S1521). The device may extract subgraph(s) that are separated by h-hops from the selected K node sets based on the number h of hops for the configured subgraph (S1531).

Alternatively, when the latent vector of the subgraph is not transmitted for the first time (No in S1510), the transmission cycle of the subgraph is reached (Yes in S1512), or the GNN model is coarse/fine-tuned (Yes in S1522), the device may use the subgraph(s) used for the coarse/fine tuning to generate the latent vector (S1532).

The device may generate a latent vector for each of the extracted subgraph(s) or the subgraph(s) used for coarse/fine tuning of the GNN model (S1541). In this case, the device may generate a latent vector for each subgraph by using an encoding portion (e.g., GNN layer+pooling) in a GNN model using a pooling scheme.

The device may record rankings of the top K node sets selected for subgraph extraction as subgraph-related information (S1551).

The device may transmit the subgraph-related information (S1561). The subgraph-related information includes, for example, the latent vector of the subgraph, the feature map for each encoding block (one encoding block includes GNN+pooling, and the feature map may be seen as the output of the GNN), and index(es) of node(s) selected during a pooling operation for each encoding block.

In the example of FIG. 15, some operations may be omitted depending on the situation and/or settings.

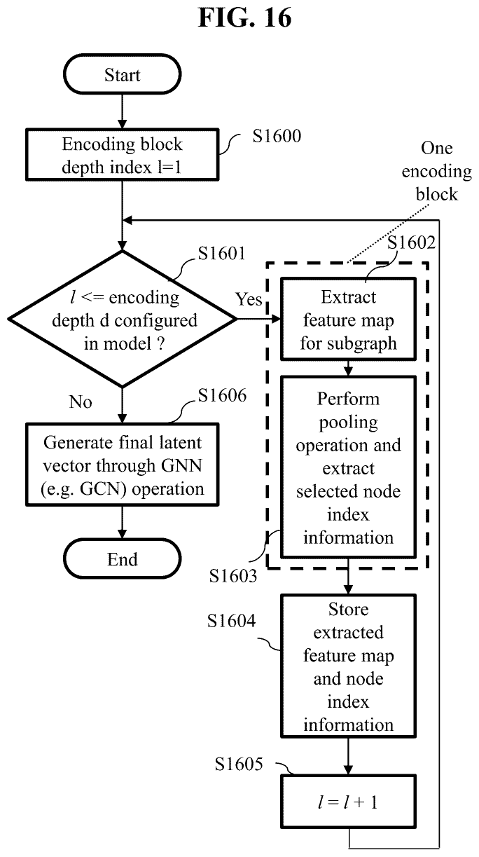

FIG. 16 shows an example of an encoding process in a GNN model using a pooling scheme according to some implementations of the present disclosure. In particular, FIG. 16 illustrates an order in which the GNN model using the pooling scheme to obtain the latent vector of the subgraph in FIG. 15 operates.

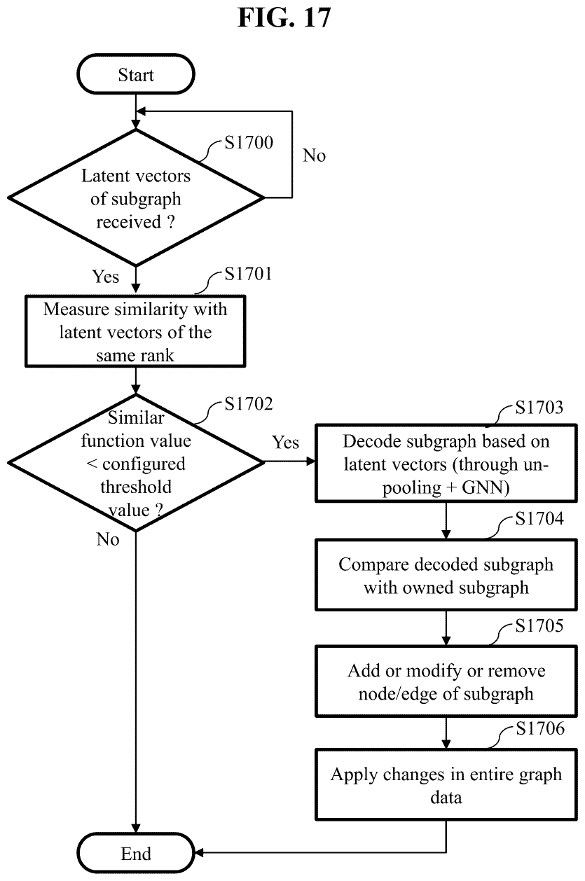

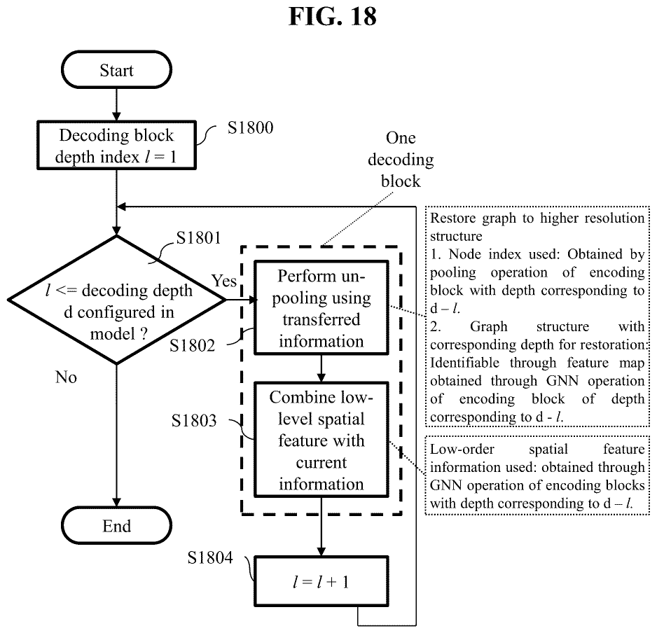

When a depth index l of the current encoding block is less than or equal to a depth d of an encoding block that is configured in the GNN model using the pooling scheme (Yes in S1601), the device obtains a feature map formed by aggregating feature(s) of nodes belonging to a subgraph through a GNN (e.g., GCN) layer from among layers belonging to the encoding block (S1602), and the information is stored in the device (S1604). As the device selects the top N node(s) or node(s) with the top N % ratio according to an importance score configured in the graph data processing-related initialization (S1201) of FIG. 12 in a pooling layer, the device may encode features while reducing the size of a graph and determine index information of the selected node (S1603). For example, the device may rank the sets of nodes belonging to the subgraph according to scores and select the top K nodes from among the sets. The importance score used when the device selects the node(s) in the pooling layer is obtained through learning of the GNN model, and through this, the index information of the selected node is stored in the device (S1604). The reduced graph obtained as a result of GNN layer+graph pooling is used as input to the next GNN layer+graph pooling (S1605). After the device performs an operation as much as a configured depth of encoding blocks (i.e., the configured number of encoding blocks) (S1605) (No in S1601), the final latent vector is obtained (S1606). Information obtained through each layer in the GNN model using the pooling scheme may be used to restore subgraph information from the latent vector in a decoder operation of FIG. 17 and/or FIG. 18, which will be described below.

In the example of FIG. 16, some operations may be omitted depending on the situation and/or settings.

FIG. 17 illustrates a process of processing subgraph-based latent vector(s) according to some implementations of the present disclosure. In particular, FIG. 17 illustrates an order of operation S1203 of processing the latent vectors received in FIG. 12.

The device may receive the latent vector of the subgraph (Yes in S1700). When K node sets with high scores are selected to generate K subgraphs in a peer device, the device may receive K latent vectors. The device may obtain respective similarity values by comparing the latent vectors of the subgraphs generated by the device with the latent vectors of the subgraphs of the same ranking through a configured similarity function (S1701). For example, the device can measure similarity by comparing similarity functions (e.g., cosine, Jaccard, or overlap coefficient) configured with the latent vector generated through the GNN and the received latent vector.

When the corresponding similarity value is compared with the similarity threshold value configured in S1201 of FIG. 12, if the corresponding similarity value is less than the similarity threshold value (Yes in S1702), the device may extract graph decoding through graph decoding for the received latent vector (S1703). In this case, through a decoding portion (e.g., un-pooling+GNN) in the GNN model using the pooling scheme, the device may perform a process of restoring a subgraph from the latent vector by using information received together with the latent vector when receiving the latent vector. This may be seen as an operation of a semantic decoder in semantic communication at a level B in FIG. 8. By comparing the subgraph restored through the decoding operation with the subgraph held for transmission of the most recent latent vector (S1704), the device may add/edit/modify/remove nodes/edges of the existing subgraph (S1705) and apply the same to the entire graph data (S1706).

In the example of FIG. 17, some operations may be omitted depending on the situation and/or settings.

FIG. 18 shows an example of a decoding process in a GNN model using a pooling scheme according to some implementations of the present disclosure. In particular, FIG. 18 illustrates an order of an operation of decoding a subgraph through a latent vector in the example of FIG. 17 (see S1703 in FIG. 17).

The device may restore the subgraph by iterating decoding using latent vectors as much as a configured decoding depth d. In other words, the device may restore the subgraph by decoding the received latent vector through d decoding blocks. Each decoding block of the device may include an un-pooling layer and a GNN layer. The device may restore the subgraph from the received latent vector based on information (e.g., node index information or feature map) received from a peer device. For example, an un-pooling layer from among layers belonging to a l-th decoding block of the device may restore a subgraph to a higher resolution structure by using a graph structure at a corresponding depth to be identified from a feature map of the l-th decoding block (i.e., in the case of the first decoding block, the received latent vector, otherwise output of (l−1)th decoding block) and a feature map obtained through node index information obtained through a pooling layer of a peer encoding block of a structure symmetrical to the l-th decoding block and a GNN layer of the peer encoding block (S1802). Here, output of the (l−1)-th decoding block corresponds to a low-level spatial feature in terms of the l-th decoding block. For example, an un-pooling layer of a decoding block with a decoding block depth index l may restore a subgraph to a higher resolution structure by using a feature map obtained through a GNN layer and node index information obtained through a pooling layer belonging to an encoding block (i.e., a peer encoding block of the decoding block with a decoding block depth index l from among encoding blocks of a peer device) with an encoding block depth (d−l). In this case, a node corresponding to node index information obtained through a pooling layer of an encoding block uses features obtained from a feature map of the corresponding decoding block, and the other nodes are set to 0 as a feature. Then, a feature map suitable for the subgraph structure at the current time (e.g., corresponding layer) may be obtained by combining a subgraph obtained through un-pooling with a feature map (i.e., low-level spatial feature information) obtained through a GNN layer of a peer encoding block of a structure symmetrical to the corresponding layer at a GNN (e.g., GCN) layer (S1803). The low-order spatial feature information used in a decoding block with a decoding block depth index l may be obtained through a GNN operation of a peer encoding block of the decoding block (i.e., the encoding block of encoding block depth (d−l)). The low-level spatial feature information may be provided from an encoding device including the encoding block to a decoding device including the decoding block. In some implementations of the present disclosure, the device may receive and utilize information from the encoding portion in relation to decoding. The information received from the encoding portion for decoding is used to apply a similar method to a method of increasing decoder performance by combining local information of a shallow layer (in which not many convolution+pooling operation are performed) in the CNN with global semantic information in a deep layer. The feature map obtained through graph un-pooling+GNN layer corresponding to a decoding block depth index l is used as input to next graph un-pooling+GNN layer (corresponding to the decoding block depth index l+1). After a decoding operation for a configured depth is performed by the device, the subgraph finally used as an input to the encoder portion may be obtained in the decoder portion of the device.

In the example of FIG. 18, some operations may be omitted depending on the situation and/or settings.

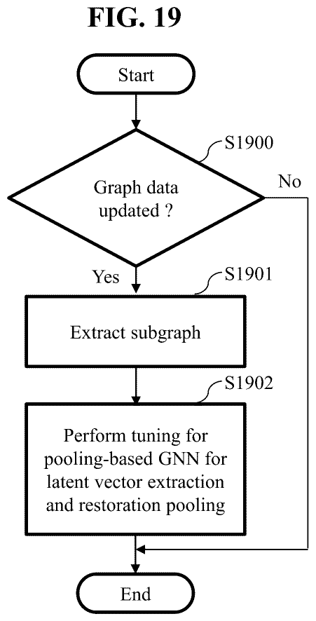

FIG. 19 shows an example of a process of updating a graph encoder/decoder to apply updated graph data according to some implementations of the present disclosure. In particular, FIG. 18 illustrates an order of an operation of updating the encoder/decoder based on updated graph data in the example of FIG. 12 (see S1204 in FIG. 12).

When the graph data is updated (Yes in S1900), the device may extract subgraph(s) from the updated graph data (S1901). For example, the device may select K node sets through a score function based on information configured in an initialization process related to graph data processing, and determine K subgraphs based on node sets that are h-hops away from each other based on the number h of hops for the subgraph(s). The device may update the graph encoder/decoder of the pooling-based GNN system by obtaining a latent vector from each subgraph and performing coarse or fine tuning on a pooling-based GNN for extraction and restoration of the latent vector (S1902).

This process may be performed to more suitably perform representation of the updated graph data and to also more suitably restore graph data from the latent vector by an encoder-decoder of the pooling-based GNN model by coarse/fine tuning on the encoding-decoding operation of the GNN model using the pooling scheme when the graph data is updated. Without transmitting subgraph-related information wirelessly between the source and the destination, the GNN model using the pooling scheme is updated through the encoder-decoder operation within the semantic encoder-decoder models held by the source and the destination.

In the example of FIG. 18, some operations may be omitted depending on the situation and/or settings.

In the example of FIG. 18, the device extracts the subgraph when updating the graph encoder/decoder of the pooling-based GNN, and thus, in the example of FIG. 14, the subgraph already extracted in S1441 may be used to generate a latent vector.

In some implementations of the present disclosure, a subgraph is extracted from a system supporting semantic communication using knowledge representation based on graph data, and a latent vector is generated from the subgraph by using a GNN to which a pooling scheme is applied. In some implementations of the present disclosure, to improve decoding performance, a feature map and index information of a selected node are generated for each layer of the encoding block, and the similarity between the generated latent vectors and the latent vectors of the same rank is measured from among i) the generated latent vector, and ii) the latent vector included in the received information. The source and the destination according to some implementations of the present disclosure may periodically perform a process of updating graph data through a decoding process that restores the subgraph by using the latent vectors respectively received by the source and the destination and the transmitted information for each layer, thereby increasing the similarity between the graph data held locally by each of the destination and the source. According to some implementations of the present disclosure, the pooling-related end-to-end scheme may be applied to a semantic communication environment, and the prediction task for concepts transmitted in semantic communication may be performed more suitably.

In some implementations of the present disclosure, graph data-based semantic communication is performed. In a wireless communication system supporting graph data-based semantic communication according to some implementations of the present disclosure, the UE, BS, or server corresponding to the source may transmit information related to graph data update to the peer device. For example, in some implementations of the present disclosure, the device may receive a configuration message including information for operating a GNN-based model using a pooling scheme from a UE, a BS, or a server. The UE, BS, or server corresponding to the source may transmit a feature map for each layer and/or node index information and final latent vector obtained through a GNN-based model using the pooling scheme according to a graph data transmission cycle to a peer UE, peer BS, or peer server corresponding to the destination. The UE/BS/server corresponding to the source may determine whether the subgraph update event occurrence conditions are satisfied by measuring the similarity between the latent vector determined or generated by the UE/BS/server and the latent vector received from the peer UE/BS/server. When the result of the similarity measurement between the latent vector generated by the device and the latent vector received from the peer device satisfies the subgraph update event occurrence condition, the corresponding UE/BS/server may restore the subgraph through a decoding operation from the received latent vector by using a node index selected from a feature map for each received layer (e.g., for each encoding block) and a node index selected in the corresponding layer, update an node/edge according to the restored subgraph, and apply the updated subgraph to the entire graph data. As such, the source and destination may have shared knowledge.

A communication device may perform operations according to several implementations of the present disclosure with respect to updating knowledge for semantic communication. In some implementations of the present disclosure, the communication device may include: at least one transceiver; at least one processor; and at least one computer memory operably connected to the at least one processor and configured to store instructions that, when executed, cause the at least one processor to perform the operations according to some implementations of the present disclosure. In some implementations of the present disclosure, the communication device, a processing device for the communication device may include: at least one processor; and at least one computer memory operably connected to the at least one processor and configured to store instructions that, when executed, cause the at least one processor to perform the operations according to some implementations of the present disclosure. A computer-readable (non-transitory) storage medium may be configured to store at least one computer program including instructions that, when executed by at least one processor, cause the at least one processor to perform the operations according to some implementations of the present disclosure. A computer program or computer program product may include instructions stored on at least one computer-readable (non-transitory) storage medium and, when executed, cause (at least one processor) to perform the operations according to some implementations of the present disclosure.

In the communication device, the processing device, and the computer-readable (non-transitory) storage medium, and/or the computer program product, the operations may include determining a first subgraph from graph data representing the knowledge, determining a first latent vector based on pooling for the first subgraph, receiving a second latent vector, a second feature map, and a second node index from another communication device, determining whether to update the graph based on the first latent vector and the second latent vector, restoring a second subgraph through un-pooling for the second latent vector based on the second feature map and the second node index, based on a determination to update the graph data, and updating the graph data based on the second subgraph.

In some implementations of the present disclosure, the communication device may include an encoder including d encoding blocks each including a graph neural network (GNN) layer and a pooling layer. Determining the first latent vector may include inputting the first subgraph to the encoder, generating an output feature map of a l-th encoding block by aggregating features of nodes belonging to a subgraph input to the l-th encoding block through a GNN layer of the l-th encoding block, selecting a preconfigured number of nodes through a pooling layer of the l-th encoding block and determining an output subgraph of the l-th encoding block based on the selected nodes, inputting the output subgraph of the l-th encoding block to a (l+1)-th encoding block based on (l+1) being not greater than d, and determining the first latent vector from the output subgraph of the l-th encoding block based on (l+1) being greater than d.

In some implementations of the present disclosure, the method may further include transmitting a feature map for each GNN layer of the communication device and node indexes of nodes selected for each pooling layer of the communication device to the other communication device.

In some implementations of the present disclosure, the communication device may include a decoder including d decoding blocks each including a graph neural network (GNN) layer and an un-pooling layer.

In some implementations of the present disclosure, receiving the second latent vector, the second feature map, and the second node index from the other communication device may include receiving a feature map for each GNN layer of the other communication device and node indexes for each pooling layer of the other communication device.

In some implementations of the present disclosure, restoring the second subgraph through un-pooling for the second latent vector based on the second feature map and the second node index may include inputting the second latent vector, the second feature map, and the second node index to the decoder, based on [symbol] =1, restoring an output subgraph of the [symbol] -th decoding block based on the second latent vector, the second feature map, and the second node index through an un-pooling layer of the [symbol] -th decoding block, and based on [symbol] >1, restoring the output subgraph of the [symbol] -th decoding block based on a feature map of the [symbol] -th decoding block and a feature map and node index of a peer encoding block of the [symbol] -th decoding block from among encoding blocks of the other communication device through the [symbol] -th decoding block, determining the feature map of the [symbol] -th decoding block by combining the output subgraph of the [symbol] -th decoding block through a GNN layer of the [symbol] -th decoding block with a feature map of the peer encoding block of the [symbol] -th decoding block from among encoding blocks of the other communication device, based on ( [symbol] +1) being not greater than d, inputting the feature map of the [symbol] -th decoding block to a ( [symbol] +1)-th decoding block, and determining the output subgraph of the [symbol] -th decoding block as the second subgraph based on ( [symbol] +1) being greater than d.

In some implementations of the present disclosure, determining whether to update the graph data based on the first latent vector and the second latent vector may include determining to update the graph data based on a similarity between the first latent vector and the second latent vector is lower than a predetermined threshold.

In some implementations of the present disclosure, updating the graph data based on the second subgraph may include updating a node or an edge of the first subgraph based on the second subgraph.

The examples of the present disclosure as described above have been presented to enable any person of ordinary skill in the art to implement and practice the present disclosure. Although the present disclosure has been described with reference to the examples, those skilled in the art may make various modifications and variations in the example of the present disclosure. Thus, the present disclosure is not intended to be limited to the examples set for the herein, but is to be accorded the broadest scope consistent with the principles and features disclosed herein.

The implementations of the present disclosure may be used in a BS, a UE, or other equipment in a wireless communication system.

1. A method of updating knowledge for semantic communication by a communication device in a wireless communication system, the method comprising:
determining a first subgraph from graph data representing the knowledge;
determining a first latent vector based on pooling for the first subgraph;
receiving a second latent vector, a second feature map, and a second node index from another communication device;
determining whether to update the graph data based on the first latent vector and the second latent vector;
restoring a second subgraph through un-pooling for the second latent vector based on the second feature map and the second node index, based on a determination to update the graph data; and
updating the graph data based on the second subgraph.

2. The method of claim 1, wherein the communication device includes an encoder including d encoding blocks each including a graph neural network (GNN) layer and a pooling layer, and
wherein determining the first latent vector includes:
inputting the first subgraph to the encoder;
generating an output feature map of a [symbol] -th encoding block by aggregating features of nodes belonging to a subgraph input to the [symbol] -th encoding block through a GNN layer of the [symbol] -th encoding block;
selecting a preconfigured number of nodes through a pooling layer of the [symbol] -th encoding block and determining an output subgraph of the [symbol] -th encoding block based on the selected nodes;
inputting the output subgraph of the [symbol] -th encoding block to a ( [symbol] +1)-th encoding block based on ( [symbol] +1) being not greater than d; and
determining the first latent vector from the output subgraph of the [symbol] -th encoding block based on ( [symbol] +1) being greater than d.

3. The method of claim 2, further comprising:
transmitting a feature map for each GNN layer of the communication device and node indexes of nodes selected for each pooling layer of the communication device to the other communication device.

4. The method of claim 1, wherein the communication device includes a decoder including d decoding blocks each including a graph neural network (GNN) layer and an un-pooling layer.

5. The method of claim 4, wherein receiving the second latent vector, the second feature map, and the second node index from the other communication device includes:
receiving a feature map for each GNN layer of the other communication device and node indexes for each pooling layer of the other communication device.

6. The method of claim 5, wherein restoring the second subgraph through un-pooling for the second latent vector based on the second feature map and the second node index includes:
inputting the second latent vector, the second feature map, and the second node index to the decoder;
based on [symbol] =1, restoring an output subgraph of the [symbol] -th decoding block based on the second latent vector, the second feature map, and the second node index through an un-pooling layer of the [symbol] -th decoding block, and based on [symbol] >1, restoring the output subgraph of the [symbol] -th decoding block based on a feature map of the [symbol] -th decoding block and a feature map and node index of a peer encoding block of the [symbol] -th decoding block from among encoding blocks of the other communication device through the [symbol] -th decoding block;
determining the feature map of the [symbol] -th decoding block by combining the output subgraph of the [symbol] -th decoding block through a GNN layer of the [symbol] -th decoding block with a feature map of the peer encoding block of the [symbol] -th decoding block from among encoding blocks of the other communication device;
based on ( [symbol] +1) being not greater than d, inputting the feature map of the [symbol] -th decoding block to a ( [symbol] +1)-th decoding block; and
determining the output subgraph of the [symbol] -th decoding block as the second subgraph based on ( [symbol] +1) being greater than d.

7. The method of claim 1, wherein determining whether to update the graph data based on the first latent vector and the second latent vector includes:
determining to update the graph data based on a similarity between the first latent vector and the second latent vector is lower than a predetermined threshold.

8. The method of claim 1, wherein updating the graph data based on the second subgraph includes:
updating a node or an edge of the first subgraph based on the second subgraph.

9. A communication device for updating knowledge for semantic communication in a wireless communication system, the communication device comprising:
at least one transceiver;
at least one processor; and
at least one computer memory operably connected to the at least one processor and configured to store instructions that, when executed, cause the at least one processor to perform operations including:
determining a first subgraph from graph data representing the knowledge;
determining a first latent vector based on pooling for the first subgraph;
receiving a second latent vector, a second feature map, and a second node index from another communication device;
determining whether to update the graph data based on the first latent vector and the second latent vector;
restoring a second subgraph through un-pooling for the second latent vector based on the second feature map and the second node index, based on a determination to update the graph data; and
updating the graph data based on the second subgraph.

10. (canceled)

11. A computer-readable storage medium for storing at least one program code including instructions that, when executed by at least one processor, cause the at least one processor to perform operations comprising:
determining a first subgraph from graph data representing knowledge;
determining a first latent vector based on pooling for the first subgraph;
receiving a second latent vector, a second feature map, and a second node index from another communication device;
determining whether to update the graph data based on the first latent vector and the second latent vector;
restoring a second subgraph through un-pooling for the second latent vector based on the second feature map and the second node index, based on a determination to update the graph data; and
updating the graph data based on the second subgraph.
